(19) United States
(12) Patent Application Publication
(10) Pub. No.: US 2019/0327220 A1
(43) Pub. Date: Oct. 24, 2019

(54) METHOD, APPARATUS, AND COMPUTER PROGRAM PRODUCT FOR SECURE DIRECT REMOTE SERVER COMMUNICATION OF ENCRYPTED GROUP-BASED COMMUNICATION DATA WITH SECURITY CONTROLS

(71) Applicant: SLACK TECHNOLOGIES, INC., San Francisco, CA (US)

(72) Inventors: Ryan HUBER, San Francisco, CA (US); Nathan BROWN, San Francisco, CA (US)

(21) Appl. No.: 15/959,448

(22) Filed: Apr. 23, 2018

(51) Int. Cl. H04L 29/06; H04L 29/08; H04L 12/751; H04L 9/08; H04L 9/32

(52) U.S. Cl. CPC H04L 63/065; H04L 67/104; H04L 45/02; H04L 63/18; H04L 9/0841; H04L 9/3268; H04L 63/0823; H04L 63/0428

(57) ABSTRACT

Embodiments of the present disclosure provide methods, systems, apparatuses, and computer program products for secure direct remote server communication of encrypted group-based communication data with security controls.

### BACKGROUND

A communication system may require message packets to be passed between various host servers spread across a vast geographical area. Applicant has identified a number of deficiencies and problems associated with secure direct host server to host server communication of encrypted messaging data. Through applied effort, ingenuity, and innovation, many of these identified problems have been solved by developing solutions that are included in embodiments of the present disclosure, many examples of which are described in detail herein.

### BRIEF SUMMARY

This specification relates to secure direct remote server communication of encrypted group-based communication data with security controls. Embodiments of the present disclosure enable the establishment of secure communication tunnels between remote server nodes such that the remote server nodes may directly communicate encrypted group-based communication data to one another while enforcing security controls.

In embodiments, an apparatus for secure direct remote server communication of encrypted group-based communication data is configured to receive, from a remote server node, a first group-based communication data packet intended for a responder remote server node. In embodiments, the responder remote server node is associated with a responder remote server node Internet protocol (IP) address.

In embodiments, upon determining that the responder remote server node Internet protocol (IP) address is not stored in a local node address map data structure, the apparatus simultaneously transmits a remote server node address map requests to one or more discovery nodes of a plurality of discovery nodes having discovery node Internet protocol (IP) addresses stored in the local node address map data structure. In embodiments, the remote server node address map requests comprises the responder remote server Internet protocol (IP) address.

In embodiments, the apparatus is configured to receive, from one or more discovery nodes, remote server node address map response messages. In embodiments, the remote server node address map response messages comprise the responder remote server Internet protocol (IP) address and a remote server node Internet protocol (IP) address data structure comprising a plurality of remote server node Internet protocol (IP) address port pairs. In embodiments, each remote server Internet protocol (IP) address port pair comprises a real Internet protocol (IP) address and an associated communication port for communicating with the responder remote server node.

In embodiments, the apparatus is configured to transmit, to the responder remote server node using a remote server node Internet protocol (IP) address port pair, a first handshake stage one message. In embodiments, the first handshake stage one message comprises a first digital certificate and a first ephemeral key pair (e1) and a first static key pair (s1). In embodiments, the first static key pair (s1) is extracted from the first digital certificate. In embodiments, the first digital certificate containing verified initiator remote server node identity credentials.

In embodiments, the apparatus is configured to receive, from the responder remote server node, a first handshake stage two message. In embodiments, the first handshake stage two message comprises a second digital certificate containing verified responder remote server node identity credentials for the responder remote server node, a second ephemeral key pair (e2), a second static key pair (s2), a first Diffie-Hellman key (e1e2) determined by performing a first Diffie-Hellman operation on the first ephemeral key pair (e1) and the second ephemeral key pair (e2), a second Diffie-Hellman key (s1e2) determined by performing a second Diffie-Hellman operation on the first static key (s1) and the second ephemeral key pair (e2), and a third Diffie-Hellman key (e1 s2) determined by performing a third Diffie-Hellman operation on the first ephemeral key pair (e1) and the second static key pair (s2). In embodiments, the second static is key (s2) extracted from the second digital certificate. In embodiments, the responder remote server node validates the first digital certificate before transmitting the first handshake stage two message.

In embodiments, the apparatus is configured to validate, by merging the second digital certificate with the second static key pair (s2), the responder remote server node identity credentials.

In embodiments, the apparatus is configured to encrypt the first group-based communication data packet using a first shared secret key generated based on the first Diffie-Hellman key (e1e2), the second Diffie-Hellman key (s1e2), and the third Diffie-Hellman key (e1 s2).

In embodiments, the apparatus is configured to establish a first secure communication tunnel for communication with the responder remote server node.

In embodiments, the apparatus is configured to transmit, to the responder remote server node using the first secure communication tunnel, the encrypted first group-based communication data packet.

In embodiments, the remote server node Internet protocol (IP) address port pair is selected from the plurality of remote server node Internet protocol (IP) address port pairs based upon a programmatically determined location associated with the remote server node Internet protocol (IP) address port pair.

In embodiments, subsequent received group-based communication data packets intended for the responder remote server node are automatically encrypted using the first shared secret key and transmitted to the responder remote server node using the first secure communication tunnel.

In embodiments, the apparatus is further configured to establish a first secure discovery node communication tunnel with the first discovery node.

In embodiments, establishing the first secure discovery node communication tunnel with the first discovery node comprises receiving, from a configuration management service, the local node address map data structure. In embodiments, the local node address map data structure contains a plurality of discovery node Internet protocol (IP) addresses. In embodiments, each discovery node Internet protocol (IP) address is associated with a unique discovery node of a plurality of discovery nodes.

In embodiments, establishing the first secure discovery node communication tunnel with the first discovery node further comprises receiving, from the configuration management service, the first digital certificate containing verified initiator remote server node identity credentials. In embodiments, the verified initiator remote server node identity credentials having been verified by the configuration management service.

In embodiments, establishing the first secure discovery node communication tunnel with the first discovery node further comprises transmitting, to a first discovery node of the plurality of discovery nodes by using a first discovery node Internet protocol (IP) address associated with the first discovery node, a second handshake stage one message. In embodiments, the second handshake stage one message comprises the first digital certificate, the first ephemeral key pair (e1) and the first static key pair (s1). In embodiments, the first digital certificate contains the first static key pair (s1).

In embodiments, establishing the first secure discovery node communication tunnel with the first discovery node further comprises receiving, from the first discovery node of the plurality of discovery nodes, a second handshake stage two message. In embodiments, the second handshake stage two message comprises a third digital certificate containing first discovery node identity credentials for the first discovery node, a third ephemeral key pair (e3), a third static key pair (s3), a fourth Diffie-Hellman key (e1e3) determined by performing a fourth Diffie-Hellman operation on the first ephemeral key pair (e1) and the third ephemeral key pair (e3), a fifth Diffie-Hellman key (s1e3) determined by performing a fifth Diffie-Hellman operation on the first static key pair (s3) and the third ephemeral key pair (e3). In embodiments, the third static key pair (s4) is extracted from the third digital certificate. In embodiments, the first discovery node validates the third digital certificate before transmitting the second handshake stage two message.

In embodiments, establishing the first secure discovery node communication tunnel with the first discovery node further comprises validating, by decrypting the second handshake stage two message, the first discovery node identity credentials.

In embodiments, establishing the first secure discovery node communication tunnel with the first discovery node further comprises transmitting, to the first discovery node by using the first discovery node Internet protocol (IP) address, a first remote server node address map update message. In embodiments, the first remote server node address map update message comprises a first secure communication system assigned Internet protocol (IP) address and a first remote server node Internet protocol (IP) address data structure comprises a plurality of remote server node Internet protocol (IP) address port pairs. In embodiments, each remote server Internet protocol (IP) address port pairs comprises a real Internet protocol (IP) address and an associated communication port.

In embodiments, the apparatus is further configured to periodically transmit to the first discovery node, using the first secure discovery node communication tunnel, remote server node address map update messages.

In embodiments, the apparatus is further configured to simultaneously establish a plurality of secure discovery node communication tunnels with each discovery node of a plurality of discovery nodes having discovery node Internet protocol (IP) addresses in the local node address map data structure.

In embodiments, the apparatus is further configured to periodically transmit to each discovery node of the plurality of discovery nodes, using the plurality of secure discovery node communication tunnels, remote server node address map update messages.

In embodiments, the apparatus is further configured to store, in the at least one memory, the second digital certificate.

In embodiments, the responder remote server node decrypts the encrypted first group-based communication data packet using the first shared secret key.

In embodiments, the responder remote server node evaluates the decrypted first group-based communication data packet using a set of security controls.

In embodiments, the set of security controls comprises at least one protocol rule, at least one port rule, and one or more of an Internet protocol (IP) address rule, a name rule, and a group rule.

Other embodiments include corresponding systems, methods, and computer programs, configured to perform the operations of the apparatus, encoded on computer storage devices.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

Having thus described the disclosure in general terms, reference will now be made to the accompanying drawings, which are not necessarily drawn to scale, and wherein:

FIG. 1 is a system architecture diagram of a group-based communication system configured to practice embodiments of the present disclosure;

FIG. 2A is an exemplary schematic diagram of a computing entity according to one embodiment of the present disclosure;

FIG. 2B is an exemplary schematic diagram of a computing entity according to one embodiment of the present disclosure;

FIG. 3 illustrates a prior art remote server node communication diagram;

FIG. 4 illustrates an exemplary secure remote server node communication diagram according to embodiments of the present disclosure;

FIGS. 5A and 5B illustrate an exemplary process for establishing a secure communication tunnel between remote server nodes, for use with embodiments of the present disclosure;

FIGS. 6A and 6B illustrate an exemplary process for configuring a remote server node and establishing secure discovery node tunnels, for use with embodiments of the present disclosure;

FIGS. 7A and 7B illustrate an exemplary process for communication by remote server nodes with a discovery node, according to embodiments of the present disclosure;

FIGS. 8A and 8B illustrate an exemplary process for secure communication of encrypted group-based communication data between remote server nodes, according to embodiments of the present disclosure;

FIG. 9 illustrates an exemplary secure remote server communication system according to embodiments of the present disclosure.

### DETAILED DESCRIPTION OF VARIOUS EMBODIMENTS

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### Overview

Various embodiments of the disclosure generally relate to secure direct remote server communication of encrypted group-based communication data with security controls. Embodiments of the present disclosure enable the establishment of secure communication tunnels between remote server nodes (i.e., hosts) such that the remote server nodes may directly communicate encrypted group-based communication data to one another while enforcing security controls. Embodiments of the present disclosure provide for securely and efficiently providing group-based communication services across multiple remote server node geographical regions having varying distances between them.

Implementations of remote server communication has historically been enabled using virtual private network (VPN) concentrator hardware from network vendors or Linux servers running as VPN tunnels. Neither of these solutions scales very well, and entire regions are lost when a VPN system or two dies between them. All traffic is bottlenecked within a few host computing entities and scaling is a very manual process. In transport mode, IPSEC must be configured to have knowledge of a public Internet protocol (IP) address to private Internet protocol (IP) address relationship for every host (i.e., remote server node) that does not share the same routable network. While this is technically possible, it is not known how IPSEC could deal with thousands upon thousands of remote server node configurations on a single host.

The inventors have identified that resources dedicated to secure server communication are easily compromised and exhausted as a result of the foregoing shortcomings. The present disclosure provides an efficient peer-to-peer alternative to historical VPN implementations that can execute on every group-based communication server (i.e., remote server node) within a group-based communication system. Such an implementation enables every group-based communication server, regardless of its geolocation, to contact every other group-based communication server directly, securely, and efficiently. Every group-based communication server behaves the same in relation to every other group-based communication server if they are physically separated by an ocean as they would if they were physically sitting next to each other.

Technological benefits provided by the present disclosure include improved enforcement of security controls when communicating encrypted group-based communication data from remote server node to remote server node, improved reliability and seamlessness of remote server node communication, improved scalability of remote server node communication across vast geolocations, and a remote server node communication system involving secure communication tunnels that are not susceptible to security attacks.

### Definitions

As used herein, the terms “data,” “content,” “digital content,” “digital content object,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The term “client device” refers to computer hardware and/or software that is configured to access a service made available by a server. The server is often (but not always) on another computer system, in which case the client device accesses the service by way of a network. Client devices may include, without limitation, smart phones, tablet computers, laptop computers, wearables, personal computers, enterprise computers, and the like.

“Group-based” is used herein to refer to a system, channel, message, or virtual environment that has security sufficient such that it is accessible only to a defined group of users. The group may be defined by common access credentials such as those of an organization or commercial enterprise. Access may further be facilitated by a validated request to join or an invitation to join transmitted by one group member user to another non-member user. Group identifiers (defined below) are used to associate data, information, messages, etc., with specific groups.

The terms “message communication” and “messaging communication” refer to any electronically generated device rendered object provided by a user using a client device and that is configured for display within a group-based communication channel. Message communications may include any text, image, video, audio or combination thereof provided by a user (using a client device). For instance, the user may provide a group-based message that includes text as well as an image and a video within the group-based message as message contents. In such a case, the text, image, and video would comprise the group-based message or device rendered object. Each message sent or posted to a group-based communication channel of the group-based communication system includes metadata comprising the following: a sending user identifier, a message identifier, message contents, a group identifier, and a group-based communication channel identifier. Each of the foregoing identifiers may comprise ASCII text, a pointer, a memory address, and the like.

The term “group-based communication channel” refers to a virtual communications environment or feed that is configured to display messaging communications posted by channel members (e.g., validated users accessing the environment using client devices) that are viewable only to the members of the group. The format of the group-based communication channel may appear differently to different members of the group-based communication channel; however, the content of the group-based communication channel (i.e., messaging communications) will be displayed to each member of the group-based communication channel. For instance, a common set of group-based messaging communications will be displayed to each member of the respective group-based communication channel such that the content of the group-based communication channel (i.e., messaging communications) will not vary per member of the group-based communication channel.

The term “user” should be understood to refer to an individual, group of individuals, business, organization, and the like; the users referred to herein are accessing a group-based communication or messaging system using client devices.

The terms “user profile,” “user account,” and “user account details” refer to information associated with a user, including, for example, a user identifier, one or more group-based communication channel identifiers associated with enterprise group-based communication channels that the user has been granted access to, one or more group identifiers for groups with which the user is associated, an indication as to whether the user is an owner of any enterprise group-based communication channels, an indication as to whether the user has any group-based communication channel restrictions, a plurality of messages, a plurality of emojis, a plurality of conversations, a plurality of conversation topics, an avatar, an email address, a real name (e.g., John Doe), a username (e.g., jdoe), a password, a real name, a time zone, a status, and the like. The user account details can include a subset designation of user credentials, such as, for example, login information for the user including the user's username and password.

The terms “group-based communication channel identifier” or “channel identifier” refer to one or more items of data by which a group-based communication channel may be identified. For example, a group-based communication channel identifier may comprise ASCII text, a pointer, a memory address, and the like.

The terms “group identifier” or “team identifier” refer to one or more items of data by which a group within a group-based communication system may be identified. For example, a group identifier may comprise ASCII text, a pointer, a memory address, and the like.

A “sending user identifier” is associated with a collection of message communications that are sent by a particular user (i.e., a client device associated with the particular user). These message communications may be analyzed to determine context regarding the user (e.g., the user's expertise or interest in a topic may be determined based on the frequency of mention of the topic or key words associated with the topic within such message communications).

Group-based communication system users are organized into organization groups (e.g., employees of each company may be a separate organization group) and each organization group may have one or more group-based communication channels (explained below) to which users may be assigned or which the users may join (e.g., enterprise group-based communication channels may represent departments, geographic locations such as offices, product lines, user interests, topics, issues, and/or the like). A group identifier may be used to facilitate access control for a message communication (e.g., access to the message communication, such as having the message communication return as part of search results in response to a search query, may be restricted to those users having the group identifier associated with their user profile). The group identifier may be used to determine context for the message communication (e.g., a description of the group, such as the name of an organization and/or a brief description of the organization, may be associated with the group identifier).

Group-based communication system users may join group-based communication channels. Some group-based communication channels may be globally accessible to those users having a particular organizational group identifier associated with their user profile (i.e., users who are members of the organization). Access to some group-based communication channels may be restricted to members of specified groups, whereby the group-based communication channels are accessible to those users having a particular group identifier associated with their user profile. The group-based communication channel identifier may be used to facilitate access control for a message communication (e.g., access to the message communication, such as having the message communication return as part of search results in response to a search query, may be restricted to those users having the group-based communication channel identifier associated with their user profile, or who have the ability to join the group-based communication channel). The group-based communication channel identifier may be used to determine context for the message communication (e.g., a description of the group-based communication channel, such as a description of a project discussed in the group-based communication channel, may be associated with the group-based communication channel identifier).

The term “private group-based communication channel” refers to a group-based communication channel with restricted access such that it is not generally accessible and/or searchable by other members of the enterprise group-based communication system. For example, only those users or administrators who have knowledge of and permission to access (e.g., a group-based communication channel identifier for the private group-based communication channel is associated with their user profile after the user has been validated/authenticated) the private group-based communication channel may view contents of the private group-based communication channel.

The term “public group-based communication channel” refers to a group-based communication channel without restricted access, such that is it generally accessible and/or searchable by other members of the enterprise group-based communication system.

The term “user identification” or “user identifier” refers to one or more items of data by which a user of a client device may be uniquely identified. In some embodiments, the user identification may be an email address, a unique identification string, an employee number, a social security number, a driver's license number, and the like.

The term “digital certificate” refers to a data file that contains identity credentials for representing a computing device's authentic Internet identity. The digital certificate is issued and/or verified by a certificate authority, third party trusted source, and/or a configuration management service. In some embodiments, identity credentials of a computing device include cryptographic keys (e.g., static key pairs).

The term “certificate authority” refers to an entity that issues digital certificates. A digital certificate certifies the ownership of a public key by the named subject of the certificate. This allows others (relying parties) to rely upon signatures or on assertions made about the private key that corresponds to the certified public key. A certificate authority acts as a trusted third party—trusted both by the subject (owner) of the certificate and by the party relying upon the certificate.

The term “configuration management service” refers to one or more computing entities (i.e., servers) that configure and manage remote server nodes and discovery nodes for use in transmitting encrypted group-based communication data. In embodiments, the configuration management service serves as a certificate authority for the remote server nodes and discovery nodes.

The term “group-based communication data packet” refers to group-based communication data intended for a particular recipient. In embodiments, the group-based communication data packet comprises group-based communication data as well as a remote server Internet protocol (IP) address through which the group-based communication data should be passed.

The terms “encrypted group-based communication data” “encrypted group-based communication data packet” refer to data for transmission within a group-based communication system from one computing entity to another, and the data is encrypted using a cryptographic scheme (i.e., Diffie-Hellman).

The term “remote server node” refers to a networked server that is physically located remotely from other networked servers that request communication with it. For example, a remote server node may be a server located in the United States while another remote server may be a server located in Europe and they may need to communicate encrypted group-based communication data between them.

The term “initiator remote server node” refers to a remote server node that initiates a handshake process in order to establish a secure communication tunnel with another remote server node (i.e., a responder remote server node).

The term “responder remote server node” refers to a remote server node that receives an initiated handshake process from an initiator remote server node looking to establish a secure communication tunnel therewith.

The term “responder remote server node Internet protocol (IP) address” refers to an Internet protocol (IP) address associated with or assigned to a responder remote server node. In some embodiments, the responder remote server node Internet protocol (IP) address is assigned to the responder remote server node by a secure communications system or a configuration management service.

The term “initiator remote server node Internet protocol (IP) address” refers to an Internet protocol (IP) address associated with or assigned to an initiator remote server node. In some embodiments, the initiator remote server node Internet protocol (IP) address is assigned to the initiator remote server node by a secure communications system or a configuration management service.

The term “local node address map data structure” refers to a data structure stored on a remote server node containing a discovery node Internet protocol (IP) address for each discovery node of a plurality of discovery nodes. In embodiments, the configuration management service provides the local node address map data structure to the remote server node at the time of initial configuration of the remote server node.

The term “discovery node” refers to a networked server that provides Internet location information about remote server nodes upon request. In embodiments, a discovery node is associated with a discovery node Internet protocol (IP) address by which remote server nodes and a configuration management service may communicate with the discovery node. In embodiments, the discovery node periodically receives updated Internet protocol (IP) address and port information from and about remote server nodes.

The term “remote server node address map request” refers to an electronic request transmitted by a remote server node to a discovery node, the request being for Internet protocol (IP) address and port information about a particular remote server node with which the remote server node would like to establish a secure communication tunnel. In embodiments, a remote server node address map request comprises an Internet protocol (IP) address that has been assigned to the particular remote server node by a configuration management service.

The term “remote server node address map response message” refers to an electronic response message transmitted by a discovery node to a requesting remote server node, the message in response to a remote server node address map request. In embodiments, the remote server node address map response message comprises an Internet protocol (IP) address that has been assigned to a particular remote server with which the requesting remote server would like to establish a secure communication tunnel, as well as a remote server node Internet protocol (IP) address data structure.

The term “remote server node Internet protocol (IP) address data structure” refers to a data structure (i.e., a protocol buffer) that contains a plurality of remote server node Internet protocol (IP) address port pairs.

The term “remote server node Internet protocol (IP) address port pairs” refers to a pair of a real Internet protocol (IP) address and an associated communication port through which a remote server node may receive electronic communications. As used herein, “real Internet protocol (IP) address” refers to an Internet protocol (IP) address that was not assigned to a remote server node by a configuration management service or other secure communications system.

The term “handshake stage one message” refers to a message transmitted from a first computing entity (e.g., remote server node) to a second computing entity (e.g., remote server node or discovery node) to initiate the establishment of a secure communications tunnel through generation of a shared secret key.

The term “handshake stage two message” refers to a message transmitted from a second computing entity (e.g., remote server node or discovery node) to a first computing entity (e.g., remote server node) in response to a validated handshake stage one message. The handshake stage two message leads to generation of a shared secret key.

The term “ephemeral key pair” refers to a temporary public key. Each instance or run of a handshake uses a different temporary public key.

The term “static key pair” refers to a long-term public key pair. The authenticity of a node's static key can be verified by validating a digital certificate associated therewith (i.e., the digital certificate contains the static key pair).

The term “remote server identity credentials” refers to electronic identity information for a remote server.

Diffie-Hellman key exchange (DH) is a method of securely exchanging cryptographic keys over a public channel and was one of the first public-key protocols as originally conceptualized by Ralph Merkle and named after Whitfield Diffie and Martin Hellman. DH is one of the earliest practical examples of public key exchange implemented within the field of cryptography. The Diffie-Hellman key exchange method allows two parties that have no prior knowledge of each other to jointly establish a shared secret key over an insecure channel. This key can then be used to encrypt subsequent communications using a symmetric key cipher.

The term “Diffie-Hellman key” refers to a shared secret key established between two parties using the Diffie-Hellman key exchange method.

The term “Diffie-Hellman operation” refers to one or more steps of the Diffie-Hellman key exchange method.

An example of the Diffie-Hellman key exchange method is illustrated below.
1. Alice chooses two prime numbers g and p and tells Bob what they are.
2. Bob then chooses a secret number (a), but does not share it with anyone. Bob computes g^{a} mod p and transmits that result “A” to Alice.
3. Alice also chooses a secret number (b), which is not shared with anyone. Alice computes g^{b} mod p and transmits the result “B” to Bob.
4. Bob then performs the operation on the result “B”: B^{a} mod p.
5. Alice then performs the operation on the result “A”: A^{b} mod p.

The answer from step 4 is the same as step 5, which results in the shared secret key. This is because (g^{a} mod p)^{b} mod p=g^{ab} mod p and (g^{b} mod p)^{a} mod p=g^{ba} mod p.

The terms “secure communication tunnel” and “secure discovery node communication tunnel” refer to a connection through which two networked computing entities may securely communicate. In computer networks, a tunneling protocol allows a network user to access or provide a network service that the underlying network does not support or provide directly. One use of a tunneling protocol is to allow a foreign protocol to run over a network that does not support that particular protocol; for example, running IPv6 over IPv4. Another use is to provide services that are impractical or unsafe to be offered using only the underlying network services; for example, providing a corporate network address to a remote user whose physical network address is not part of the corporate network. Because tunneling involves repackaging the traffic data into a different form, perhaps with encryption as standard, a third use is to hide the nature of the traffic that is run through the tunnels. A tunneling protocol works by using the data portion of a packet (the payload) to carry the packets that actually provide the service. Tunneling uses a layered protocol model such as those of the OSI or TCP/IP protocol suite, but usually violates the layering when using the payload to carry a service not normally provided by the network. Typically, the delivery protocol operates at an equal or higher level in the layered model than the payload protocol.

The term “encrypted group-based communication data packet” refers to a group-based communication data packet that has been encrypted using a shared secret key.

The term “location associated with a remote server node Internet protocol (IP) address port pair” refers to a geolocation of an IP address including latitude, longitude, city, region and country.

The term “remote server node address map update message” refers to electronic messages transmitted from remote server nodes to discovery nodes to provide updated information related to a mapping of a secure communication system assigned Internet protocol (IP) address to remote server node Internet protocol (IP) address port pairs.

The term “remote server node address map data structure” refers to a data structure containing a mapping of remote server node Internet protocol (IP) addresses to real Internet protocol (IP) addresses and their associated ports.

The term “security controls” refers to rules for blocking or allowing the passage of network traffic (i.e., encrypted group-based communication data) intended for a particular computing entity. The purpose of security controls is to reduce or eliminate the occurrence of unwanted or unauthorized network communications while allowing all legitimate communication to flow freely. In some examples, a security control can comprise a protocol rule that defines a protocol (e.g., TCP, UDP) through which network traffic may be passed. A security control can also comprise a port rule that defines a port through which network traffic may be passed to a particular computing entity. A security control can also comprise an Internet protocol (IP) address rule, a name rule, and a group rule. In embodiments, a group rule controls what communications can be transmitted to a particular user or remote server node by dictating what group or groups the remote server node or user must be a part of in order to receive the communications Similar controls are implemented using the name rules, protocol rules, port rules, Internet protocol (IP) address rules, and the like.

Historically security controls have been enforced by firewalls, which have only been concerned with Internet protocol (IP) addresses and port numbers. Such implementations become unwieldy as complexity is added. Embodiments of the present disclosure use certificates to identify remote server nodes to each other, for example a webserver (i.e., remote server node) can have a cryptographic certificate that says Host: www1234 Groups: www-server, www-server-usa, www-server-usa-amazon2, etc. This allows security controls between remote server nodes to operate based on the groups a remote server node uses to identify itself, regardless of the Internet protocol (IP) addresses the remote server node uses. The security control also resides on each remote server node and can be managed with any configuration management service or tool, and becomes vendor agnostic. This simplifies remote server node and communication system management substantially.

### Example System Architecture

Methods, apparatuses, and computer program products of the present disclosure may be embodied by any of a variety of devices. For example, the method, apparatus, and computer program product of an example embodiment may be embodied by a networked device (e.g., an enterprise platform), such as a server or other network entity, configured to communicate with one or more devices, such as one or more client devices. Additionally or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, or any combination of the aforementioned devices.

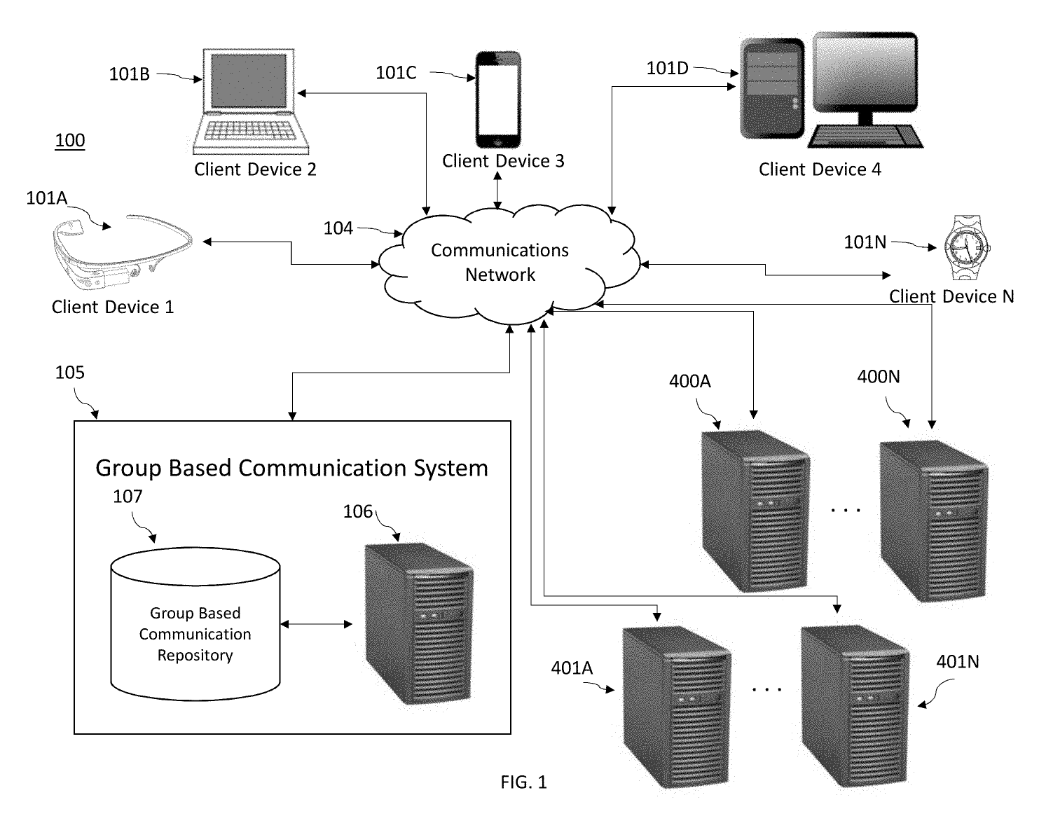

FIG. 1 illustrates an example computing system 100 within which embodiments of the present disclosure may operate. Users may access a group-based communication system 105 via a communications network 104 using client devices 101A-101N. The group-based communication system 105 may comprise an group-based communication server 106 in communication with at least one group-based communication repository 107. In embodiments, the group-based communication server 106 may comprise a configuration management service.

Communications network 104 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, communications network 104 may include a cellular telephone, an 802.11, 802.16, 802.20, and/or WiMax network. Further, the communications network 104 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the enterprise group-based communication system. In some embodiments, the protocol is a custom protocol of JSON objects sent via a Websocket channel. In some embodiments, the protocol is JSON over RPC, JSON over REST/HTTP, and the like.

The group-based communication server 106 may be embodied as a computer or computers as known in the art. The group-based communication server 106 may provide for receiving of electronic data from various sources, including but not necessarily limited to the client devices 101A-101N. For example, the group-based communication server 106 may be operable to receive and post or transmit group-based messaging communications provided by the client devices 101A-101N.

The group-based communication repository 107 may be embodied as a data storage device such as a Network Attached Storage (NAS) device or devices, or as a separate database server or servers. The group-based communication repository 107 includes information accessed and stored by the group-based communication server 106 to facilitate the operations of the group-based communication system 105. For example, the group-based communication repository 107 may include, without limitation, a plurality of messaging communications organized among a plurality of group-based communication channels, and/or the like.

The client devices 101A-101N may be any computing device as defined above. Electronic data received by the group-based communication server 106 from the client devices 101A-101N may be provided in various forms and via various methods. For example, the client devices 101A-101N may include desktop computers, laptop computers, smartphones, netbooks, tablet computers, wearables, and the like.

In embodiments where a client device 101A-101N is a mobile device, such as a smart phone or tablet, the client device 101A-101N may execute an “app” to interact with the group-based communication system 105. Such apps are typically designed to execute on mobile devices, such as tablets or smartphones. For example, an app may be provided that executes on mobile device operating systems such as iOS®, Android®, or Windows®. These platforms typically provide frameworks that allow apps to communicate with one another and with particular hardware and software components of mobile devices. For example, the mobile operating systems named above each provide frameworks for interacting with location services circuitry, wired and wireless network interfaces, user contacts, and other applications. Communication with hardware and software modules executing outside of the app is typically provided via application programming interfaces (APIs) provided by the mobile device operating system.

Additionally or alternatively, the client device 101A-101N may interact with the group-based communication system 105 via a web browser. As yet another example, the client device 101A-101N may include various hardware or firmware designed to interface with the group-based communication system 105.

In some embodiments of an exemplary group-based communication system 105, a message or messaging communication may be sent from a client device 101A-101N to an group-based communication system 105. In various implementations, the message may be sent to the group-based communication system 105 over communications network 104 directly by a client device 101A-101N, the message may be sent to the group-based communication system 105 via an intermediary such as a message server, and/or the like. For example, the client device 101A-101N may be a desktop, a laptop, a tablet, a smartphone, and/or the like that is executing a client application (e.g., an enterprise group-based communication app). In one implementation, the message may include data such as a message identifier, sending user identifier, a group identifier, a group-based communication channel identifier, message contents (e.g., text, emojis, images, links), attachments (e.g., files), message hierarchy data (e.g., the message may be a reply to another message), third party metadata, and/or the like. In one embodiment, the client device 101A-101N may provide the following example message, substantially in the form of a (Secure) Hypertext Transfer Protocol (“HTTP(S)”) POST message including eXtensible Markup Language (“XML”) formatted data, as provided below:

POST /authrequest.php HTTP/1.1
Host: www.server.com
Content-Type: Application/XML
Content-Length: 667
<?XML version = “1.0” encoding = “UTF-8”?>
<auth_request>

<timestamp>2020-12-31 23:59:59</timestamp>
<user_accounts_details>

<user_account_credentials>

<user_name>ID_user_1</user_name>
<password>abc123</password>
//OPTIONAL <cookie>cookieID</cookie>
//OPTIONAL <digital_cert_link>www.mydigitalcertificate.com/

JohnDoeDaDoeDoe@gmail.com/mycertifcate.dc</digital_cert_link>

//OPTIONAL <digital_certificate>_DATA_</digital_certificate>

</user_account_credentials>

</user_accounts_details>
<client_details> //iOS Client with App and Webkit

//it should be noted that although several client details
//sections are provided to show example variants of client
//sources, further messages will include only on to save
//space

<client_IP>10.0.0.123</client_IP>
<user_agent_string>Mozilla/5.0 (iPhone; CPU iPhone OS 7_1_1 like Mac OS X)

AppleWebKit/537.51.2 (KHTML, like Gecko) Version/7.0 Mobile/11D201
Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>app with webkit</client_app_type>
<app_installed_flag>true</app_installed_flag>
<app_name>MSM.app</app_name>
<app_version>1.0 </app_version>
<app_webkit_name>Mobile Safari</client_webkit_name>
<client_version>537.51.2</client_version>

</client_details>
<client_details> //iOS Client with Webbrowser

<client_IP>10.0.0.123</client_IP>
<user_agent_string>Mozilla/5.0 (iPhone; CPU iPhone OS 7_1_1 like Mac OS X)

AppleWebKit/537.51.2 (KHTML, like Gecko) Version/7.0 Mobile/11D201
Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>web browser</client_app_type>
<client_name>Mobile Safari</client_name>
<client_version>9537.53</client_version>

</client_details>
<client_details> //Android Client with Webbrowser

<client_IP>10.0.0.123</client_IP>
<user_agent_string>Mozilla/5.0 (Linux; U; Android 4.0.4; en-us; Nexus S Build/IMM76D)

AppleWebKit/534.30 (KHTML, like Gecko) Version/4.0 Mobile Safari/534.30</user_agent_string>

<client_product_type>Nexus S</client_product_type>
<client_serial_number>YXXXXXXXXZ</client_serial_number>
<client_UDID>FXXXXXXXXX-XXXX-XXXX-XXXX-

XXXXXXXXXXXXX</client_UDID>

<client_OS>Android</client_OS>
<client_OS_version>4.0.4</client_OS_version>
<client_app_type>web browser</client_app_type>
<client_name>Mobile Safari</client_name>
<client_version>534.30</client_version>

</client_details>
<client_details> //Mac Desktop with Webbrowser

<client_IP>10.0.0.123</client_IP>
<user_agent_string>Mozilla/5.0 (Macintosh; Intel Mac OS X 10_9_3)

AppleWebKit/537.75.14 (KHTML, like Gecko) Version/7.0.3 Safari/537.75.14</user_agent_string>

<client_product_type>MacPro5,1</client_product_type>
<client_serial_number>YXXXXXXXXZ</client_serial_number>
<client_UDID>FXXXXXXXXX-XXXX-XXXX-XXXX-

XXXXXXXXXXXXX</client_UDID>

<client_OS>Mac OS X</client_OS>
<client_OS_version>10.9.3</client_OS_version>
<client_app_type>web browser</client_app_type>
<client_name>Mobile Safari</client_name>
<client_version>537.75.14</client_version>

</client_details>
<message>

<message_identifier>ID_message_10</message_identifier>
<team_identifier>ID_team_1</team_identifier>
<channel_identifier>ID_channel_1</channel_identifier>
<contents>That is an interesting invention. I have attached a copy our patent

policy.</contents>

<attachments>patent_policy.pdf</attachments>

</message>

</auth_request>

The group-based communication system 105 comprises at least one group-based communication server 106 that may create a storage message based upon the received message to facilitate message indexing and storage in an group-based communication repository 107. In one implementation, the storage message may include data such as a message identifier, a group identifier, a group-based communication channel identifier, a sending user identifier, topics, responses, message contents, attachments, message hierarchy data, third party metadata, conversation primitive data, and/or the like. For example, the group-based communication server 106 may provide the following example storage message, substantially in the form of a HTTP(S) POST message including XML-formatted data, as provided below:

POST /storage_message.php HTTP/1.1
Host: www.server.com
Content-Type: Application/XML
Content-Length: 667
<?XML version = “1.0” encoding = “UTF-8”?>
<storage_message>

<message_identifier>ID_message_10</message_identifier>
<team_identifier>ID_team_1</team_identifier>
<channel_identifier>ID_channel_1</channel_identifier>
<sending_user_identifier>ID_user_1</sending_user_identifier>
<topics>

<topic>inventions</topic>
<topic>patents</topic>
<topic>policies</topic>

</topics>
<responses>

<response>liked by ID_user_2</response>
<response>starred by ID_user_3</response>

</responses>
<contents>That is an interesting invention. I have attached a copy our patent policy.</contents>
<attachments>patent_policy.pdf</attachments>
<conversation_primitive>

conversation includes messages: ID_message_8, ID_message_9, ID_message_10,
ID_message_11, ID_message_12

</conversation_primitive>

</storage_message>

In embodiments, a group identifier as defined above may be associated with the message.

In embodiments, a group-based communication channel identifier as defined above may be associated with the message.

In embodiments, a sending user identifier as defined above may be associated with the message. In one implementation, the message may be parsed (e.g., using PHP commands) to determine a sending user identifier of the user who sent the message.

In embodiments, topics may be associated with the message. In one implementation, the message contents may be parsed (e.g., using PHP commands) to determine topics discussed in the message. For example, hashtags in the message may indicate topics associated with the message. In another example, the message may be analyzed (e.g., by itself, with other messages in a conversation primitive) or parsed using a machine learning technique, such as topic modeling, to determine topics associated with the message.

In embodiments, data indicating responses may be associated with the message. For example, responses to the message by other users may include reactions (e.g., selection of an emoji associated with the message, selection of a “like” button associated with the message), clicking on a hyperlink embedded in the message, replying to the message (e.g., posting a message to the group-based communication channel in response to the message), downloading a file associated with the message, sharing the message from one group-based communication channel to another group-based communication channel, pinning the message, starring the message, and/or the like. In one implementation, data regarding responses to the message by other users may be included with the message, and the message may be parsed (e.g., using PHP commands) to determine the responses. In another implementation, data regarding responses to the message may be retrieved from a database. For example, data regarding responses to the message may be retrieved via a MySQL database command similar to the following:
SELECT messageResponses
FROM MSM_Message
WHERE messageID=ID_message_10.

For example, data regarding responses to the message may be used to determine context for the message (e.g., a social score for the message from the perspective of some user). In another example, data regarding responses to the message may be analyzed to determine context regarding the user (e.g., the user's expertise in a topic may be determined based on the responses to the user's message regarding the topic).

In embodiments, attachments may be included with the message. If there are attachments, files may be associated with the message. In one implementation, the message may be parsed (e.g., using PHP commands) to determine file names of the attachments. For example, file contents may be analyzed to determine context for the message (e.g., a patent policy document may indicate that the message is associated with the topic “patents”).

In embodiments, third party metadata may be associated with the message. For example, third party metadata may provide additional context regarding the message or the user that is specific to a company, group, group-based communication channel, and/or the like. In one implementation, the message may be parsed (e.g., using PHP commands) to determine third party metadata. For example, third party metadata may indicate whether the user who sent the message is an authorized representative of the group-based communication channel (e.g., an authorized representative may be authorized by the company to respond to questions in the enterprise group-based communication channel).

In embodiments, a conversation primitive may be associated with the message. In one implementation, a conversation primitive is an element used to analyze, index, store, and/or the like messages. For example, the message may be analyzed by itself, and may form its own conversation primitive. In another example, the message may be analyzed along with other messages that make up a conversation, and the messages that make up the conversation may form a conversation primitive. In one implementation, the conversation primitive may be determined as the message, a specified number (e.g., two) of preceding messages and a specified number (e.g., two) of following messages. In another implementation, the conversation primitive may be determined based on analysis of topics discussed in the message and other messages (e.g., in the channel) and/or proximity (e.g., message send order proximity, message send time proximity) of these messages.

In embodiments, various metadata, determined as described above, and/or the contents of the message may be used to index the message (e.g., using the conversation primitive) to facilitate various facets of searching (i.e., search queries that return results from group-based communication repository 107). In one implementation, a storage message may be sent from group-based communication server 106 to facilitate indexing in group-based communication repository 107. In another implementation, metadata associated with the message may be determined and the message may be indexed in group-based communication repository 107. In one embodiment, the message may be indexed such that a company's or a group's messages are indexed separately (e.g., in a separate index associated with the group and/or company that is not shared with other groups and/or companies). In one implementation, messages may be indexed at a separate distributed repository (e.g., to facilitate data isolation for security purposes).

If there are attachments associated with the message, file contents of the associated files may be used to index such files in group-based communication repository 107 to facilitate searching. In one embodiment, the files may be indexed such that a company's or a group's files are indexed at a separate distributed repository.

In embodiments of the present disclosure, a group-based communication system 105 enables worldwide communication via communications network 104 through the use of remote server nodes 400A-400N and discovery nodes 401A-401N.

### Example Apparatus for Implementing Embodiments of the Present Disclosure

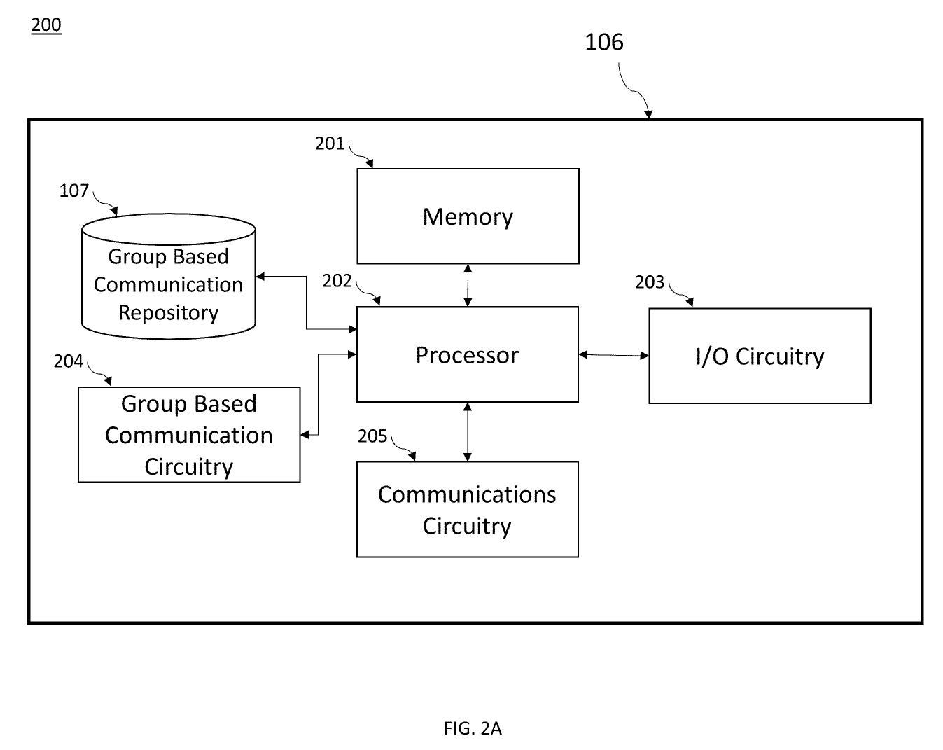

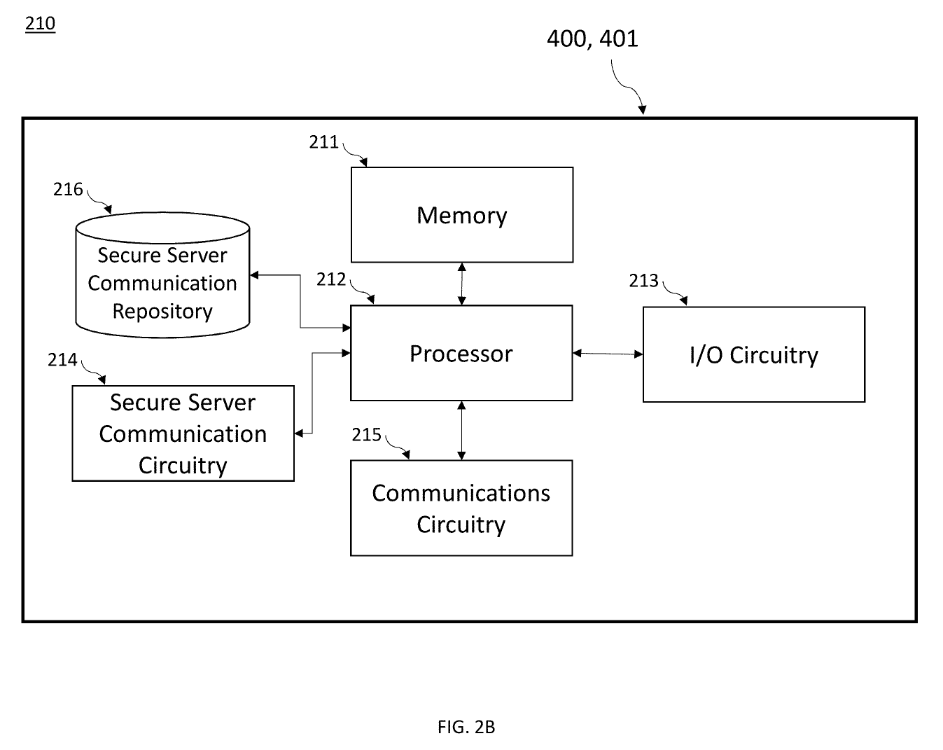

The group-based communication server 106 may be embodied by one or more computing systems, such as apparatus 200 shown in FIG. 2. The apparatus 200 may include a processor 202, a memory 201, input/output circuitry 203, communications circuitry 205, group-based communication repository 107 and group-based communication circuitry 204. The apparatus 200 may be configured to execute the operations described herein. Although the components are described with respect to functional limitations, it should be understood that the particular implementations necessarily include the use of particular hardware. It should also be understood that certain of the components described herein may include similar or common hardware. For example, two sets of circuitry may both leverage use of the same processor, network interface, storage medium, or the like to perform their associated functions, such that duplicate hardware is not required for each set of circuitry. The use of the term “circuitry” as used herein with respect to components of the apparatus should therefore be understood to include particular hardware configured to perform the functions associated with the particular circuitry as described herein.

The term “circuitry” should be understood broadly to include hardware and, in some embodiments, software for configuring the hardware. For example, in some embodiments, “circuitry” may include processing circuitry, storage media, network interfaces, input/output devices, and the like. In some embodiments, other elements of the apparatus 200 may provide or supplement the functionality of particular circuitry. For example, the processor 202 may provide processing functionality, the memory 201 may provide storage functionality, the communications circuitry 205 may provide network interface functionality, and the like.

In some embodiments, the processor 202 (and/or co-processor or any other processing circuitry assisting or otherwise associated with the processor) may be in communication with the memory 201 via a bus for passing information among components of the apparatus. The memory 201 may be non-transitory and may include, for example, one or more volatile and/or non-volatile memories. In other words, for example, the memory may be an electronic storage device (e.g., a computer readable storage medium). The memory 201 may be configured to store information, data, content, applications, instructions, or the like, for enabling the apparatus to carry out various functions in accordance with example embodiments of the present disclosure.

The processor 202 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In an example embodiment, the processor 202 may be configured to execute instructions stored in the memory 201 or otherwise accessible to the processor. Alternatively, or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present disclosure while configured accordingly. Alternatively, as another example, when the processor is embodied as an executor of software instructions, the instructions may specifically configure the processor to perform the algorithms and/or operations described herein when the instructions are executed.

In some embodiments, the apparatus 200 may include input/output circuitry 203 that may, in turn, be in communication with processor 202 to provide output to the user and, in some embodiments, to receive an indication of a user input. The input/output circuitry 203 may comprise a user interface and may include a display and may comprise a web user interface, a mobile application, a client device, a kiosk, or the like. In some embodiments, the input/output circuitry 203 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 201, and/or the like).

The communications circuitry 205 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 205 may include, for example, a network interface for enabling communications with a wired or wireless communication network. For example, the communications circuitry 205 may include one or more network interface cards, antennae, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s).

The group-based communication circuitry 204 includes hardware configured to support a group-based communication system. The group-based communication circuitry 204 may utilize processing circuitry, such as the processor 202, to perform these actions. The group-based communication circuitry 204 may send and/or receive data from group-based communication repository 107. In some implementations, the sent and/or received data may be of digital content objects organized among a plurality of group-based communication channels. It should also be appreciated that, in some embodiments, the group-based communication circuitry 204 may include a separate processor, specially configured field programmable gate array (FPGA), or application specific interface circuit (ASIC).

FIG. 2B is an exemplary schematic diagram of a computing entity according to one embodiment of the present disclosure. The remote server nodes 400A-400N and discovery nodes 401A-401N may be embodied by one or more computing systems, such as apparatus 210 shown in FIG. 2B. The apparatus 210 may include a processor 212, a memory 211, input/output circuitry 213, communications circuitry 215, secure server communication repository 216 and secure server communication circuitry 214. The apparatus 210 may be configured to execute the operations described herein. Although the components are described with respect to functional limitations, it should be understood that the particular implementations necessarily include the use of particular hardware. It should also be understood that certain of the components described herein may include similar or common hardware. For example, two sets of circuitry may both leverage use of the same processor, network interface, storage medium, or the like to perform their associated functions, such that duplicate hardware is not required for each set of circuitry. The use of the term “circuitry” as used herein with respect to components of the apparatus should therefore be understood to include particular hardware configured to perform the functions associated with the particular circuitry as described herein.

The term “circuitry” should be understood broadly to include hardware and, in some embodiments, software for configuring the hardware. For example, in some embodiments, “circuitry” may include processing circuitry, storage media, network interfaces, input/output devices, and the like. In some embodiments, other elements of the apparatus 210 may provide or supplement the functionality of particular circuitry. For example, the processor 212 may provide processing functionality, the memory 211 may provide storage functionality, the communications circuitry 215 may provide network interface functionality, and the like.

In some embodiments, the processor 212 (and/or co-processor or any other processing circuitry assisting or otherwise associated with the processor) may be in communication with the memory 211 via a bus for passing information among components of the apparatus. The memory 211 may be non-transitory and may include, for example, one or more volatile and/or non-volatile memories. In other words, for example, the memory may be an electronic storage device (e.g., a computer readable storage medium). The memory 211 may be configured to store information, data, content, applications, instructions, or the like, for enabling the apparatus to carry out various functions in accordance with example embodiments of the present disclosure.

The processor 212 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In an example embodiment, the processor 212 may be configured to execute instructions stored in the memory 211 or otherwise accessible to the processor. Alternatively, or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present disclosure while configured accordingly. Alternatively, as another example, when the processor is embodied as an executor of software instructions, the instructions may specifically configure the processor to perform the algorithms and/or operations described herein when the instructions are executed.

In some embodiments, the apparatus 210 may include input/output circuitry 213 that may, in turn, be in communication with processor 212 to provide output to the user and, in some embodiments, to receive an indication of a user input. The input/output circuitry 213 may comprise a user interface and may include a display and may comprise a web user interface, a mobile application, a client device, a kiosk, or the like. In some embodiments, the input/output circuitry 213 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 211, and/or the like).

The communications circuitry 215 may be any means such as a device or circuitry embodied in either hardware or a combination of hardware and software that is configured to receive and/or transmit data from/to a network and/or any other device, circuitry, or module in communication with the apparatus 210. In this regard, the communications circuitry 215 may include, for example, a network interface for enabling communications with a wired or wireless communication network. For example, the communications circuitry 215 may include one or more network interface cards, antennae, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s).

The secure server communication circuitry 214 includes hardware configured to support a secure server communication system as described herein. The secure server communication circuitry 214 may utilize processing circuitry, such as the processor 202, to perform these actions. The secure server communication circuitry 214 may send and/or receive data from secure server communication repository 216. In some implementations, the sent and/or received data may be of digital content objects organized among a plurality of group-based communication channels. It should also be appreciated that, in some embodiments, the secure server communication circuitry 214 may include a separate processor, specially configured field programmable gate array (FPGA), or application specific interface circuit (ASIC).

As described above and as will be appreciated based on this disclosure, embodiments of the present disclosure may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

### Example Processes for Secure Direct Remote Server Communication of Encrypted Group-Based Communication Data with Security Controls

Embodiments of the present disclosure enable a high performance encrypted communications channel system with security controls. In embodiments, the present disclosure utilizes the Noise Protocol Framework. The present embodiments use certificates to assert a discovery node or remote server node's Internet protocol (IP) address, name, and membership within user-defined groups (e.g., group based communication groups or teams). User-defined groups within the high performance encrypted communications channel system of the present disclosure allow for provider agnostic traffic filtering between remote server nodes and discovery nodes. Discovery nodes allow individual peers (i.e., remote server nodes) to find each other and optionally use UDP hole punching to establish connections from behind most firewalls or NATs. Users can move data between remote server nodes in any number of cloud service providers, datacenters, and endpoints, without needing to maintain a particular addressing scheme. Embodiments of the present disclosure use elliptic curve Diffie-Hellman key exchange and AES-256-GCM. It will be appreciated that these are non-limiting examples of key exchange and encryption schemes that can be used with embodiments of the present disclosure.

Embodiments of the present disclosure provide for running secure group-based communication services in different remote server node geographical regions. Historically, such communication services have been enabled using virtual private network (VPN) concentrator hardware from network vendors or Linux servers running as VPN tunnels. Neither of these solutions scales very well, and entire regions are lost when a VPN system or two dies between them. The present disclosure provides a high performance peer-to-peer alternative to traditional VPN's that can be executed on every group-based communication server (i.e., remote server node) within a group-based communication system. Such an implementation enables every group-based communication server, regardless of its geolocation, to contact every other group-based communication server directly, securely, and efficiently. Every group-based communication server behaves the same in relation to every other group-based communication server if they are physically separated by an ocean as they would if they were physically sitting next to each other.

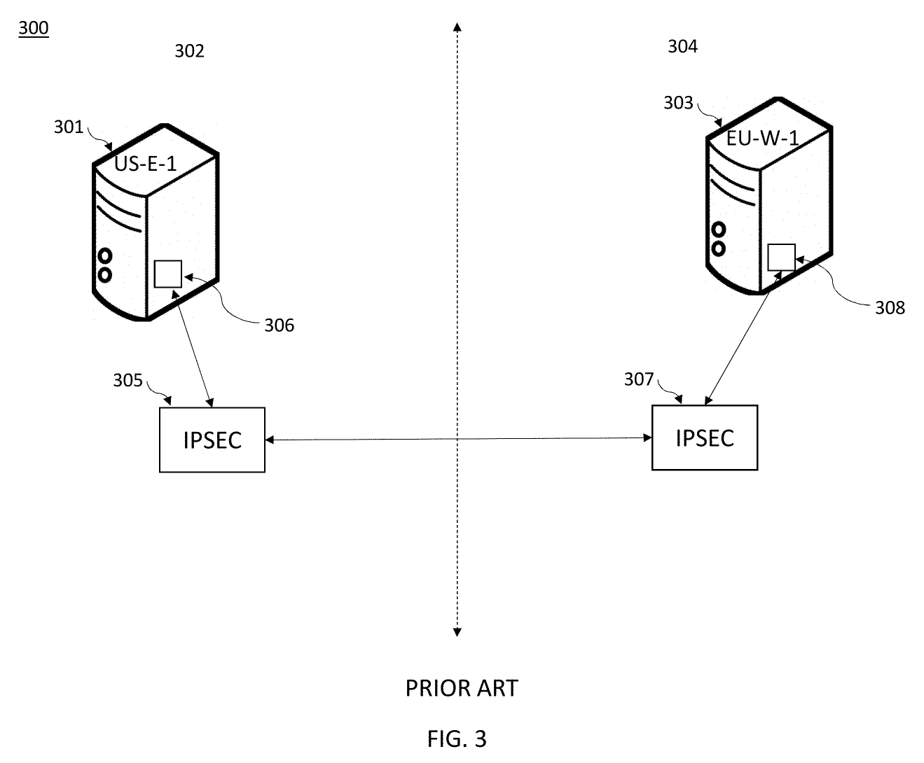

FIG. 3 illustrates a prior art remote server communication diagram. The prior art diagram 300 illustrated in FIG. 3 includes two servers 301, 303 that are remote from one another, meaning located in different geographical regions. Specifically, server 301 is in region 302, which may be eastern United States, while server 303 is in region 304, which may be western Europe. In order to communicate with one another, each of servers 301, 303 must connect through a port 306, 308 to an IPSEC tunnel 305, 307 such that any packets to be communicated must be encrypted and wrapped by IPSEC before transmitting to the intended server. There are significant drawbacks to such an implementation, including that all traffic is bottlenecked within a few host computing entities and scaling is a very manual process. In transport mode, IPSEC must be configured to know a public Internet protocol (IP) address: private Internet protocol (IP) address relationship for every host (i.e., remote server node) that does not share the same routable network. While this is technically possible, it is not known how IPSEC could deal with thousands upon thousands of remote server node configurations on a single host.

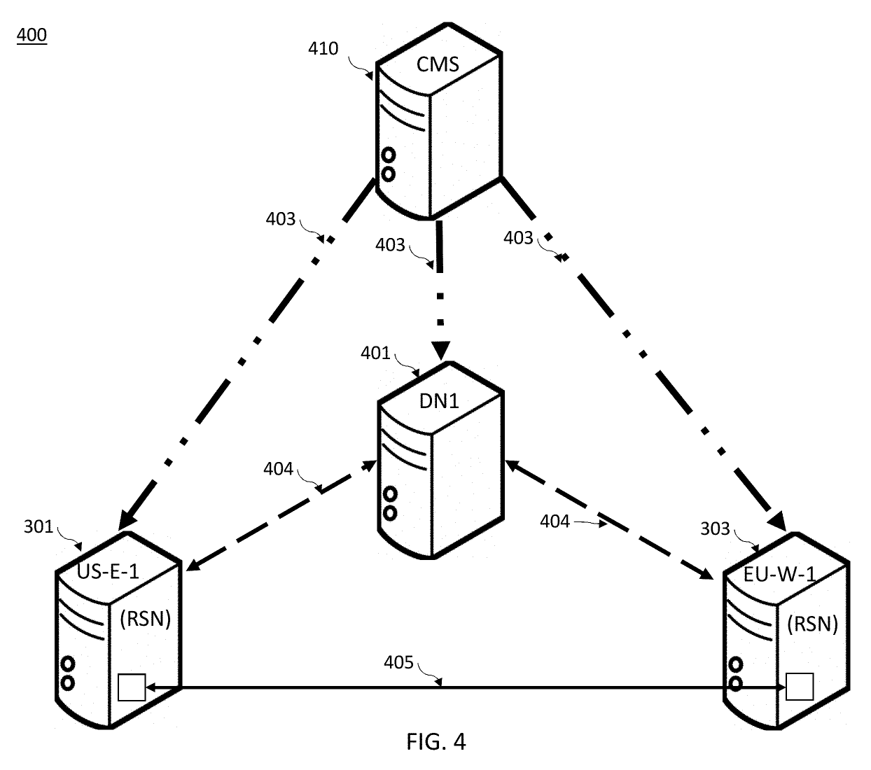

FIG. 4 illustrates an exemplary secure remote server communication diagram 400 according to embodiments of the present disclosure. In exemplary embodiments of the present disclosure, a configuration management service 410 can provision or configure discovery nodes (e.g., DN1 401) by transmitting configuration instructions (examples shown by arrows 403) and address map data structures including Internet protocol (IP) addresses for all other discovery nodes in the secure communication system. The configuration management service 410 can also provision or configure remote server nodes (e.g., 301, 303) by transmitting configuration instructions (examples shown by arrows 403) and address map data structures including Internet protocol (IP) addresses for all discovery nodes in the secure communication system. Subsequently, remote server nodes 301, 301 can establish secure communication tunnels with a discovery node 401 (shown by arrows 404) for the ability to discover other remote server nodes within the secure communication system. Finally, remote server nodes 301, 303 can establish a secure communication tunnel between them (shown by arrow 405) so that they may securely and directly communicate encrypted group-based communication data.

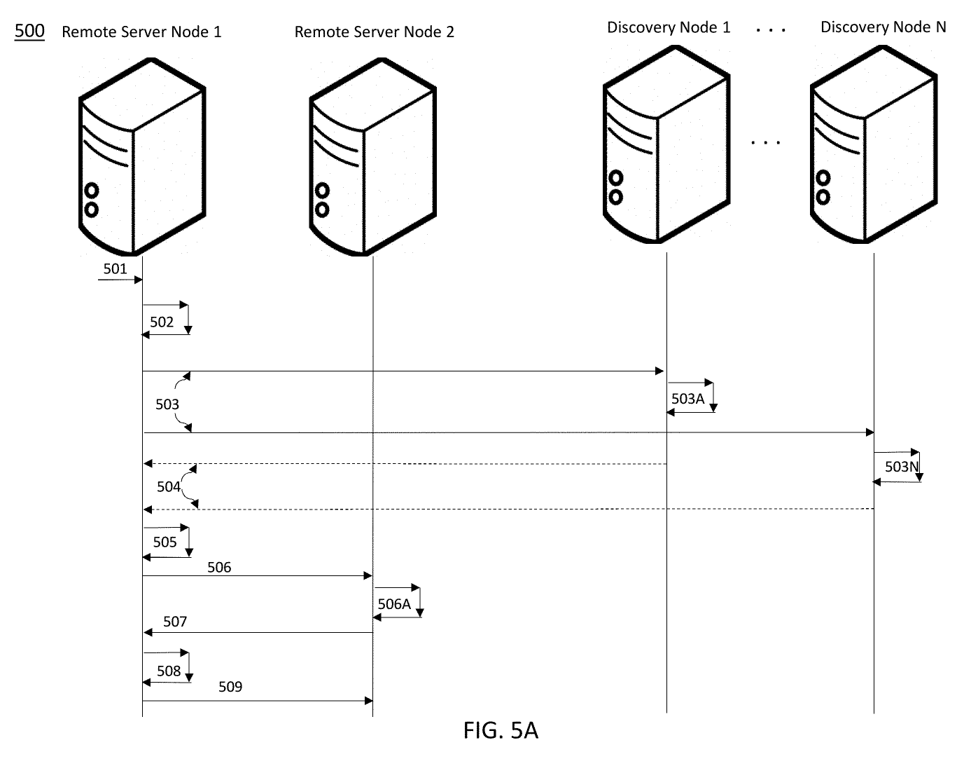

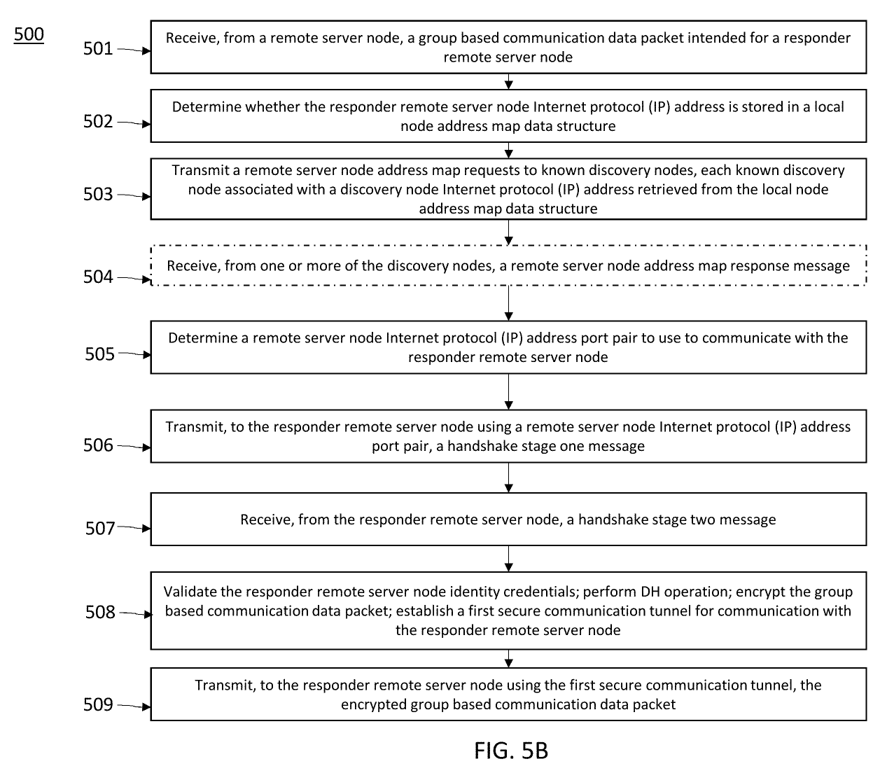

FIGS. 5A and 5B illustrate an exemplary process for establishing a secure communication tunnel between remote server nodes, for use with embodiments of the present disclosure. According to embodiments, a process 500 for establishing a secure communication tunnel between remote server nodes can be performed by an apparatus for secure direct remote server communication of encrypted group-based communication data with security controls, the apparatus comprising at least one processor and at least one memory storing instructions that, when executed by the at least one processor, cause the apparatus to perform steps of the process 500.

In embodiments, process 500 begins with a Remote Server Node 1 receiving 501, from another remote server node, a first group-based communication data packet intended for a responder remote server node (Remote Server Node 2). In embodiments, the responder remote server node (Remote Server Node 2) is associated with a responder remote server node Internet protocol (IP) address.

In embodiments, process 500 continues with the Remote Server Node 1 determining 502 whether the responder remote server node Internet protocol (IP) address is stored in a local node address map data structure (e.g., stored in memory of the Remote Server Node 1). Upon determining that the responder remote server node Internet protocol (IP) address is not stored in the local address map data structure, Remote Server Node 1 simultaneously transmits 503 remote server node address map requests to all discovery nodes known to it (e.g., Discovery Node 1, . . . Discovery Node N). In embodiments, the discovery nodes are associated with discovery node Internet protocol (IP) addresses retrieved from the local node address map data structure. In embodiments, a remote server node address map request comprises the responder remote server Internet protocol (IP) address. In embodiments, each discovery node retrieves (503A . . . 503N) data to be returned in a remote server node address map response message.

In embodiments, process 500 continues with the Remote Server Node 1 receiving 504, from one or more of the discovery nodes (Discovery Node 1, . . . Discovery Node N), a remote server node address map response message. In embodiments, a remote server node address map response message comprises the responder remote server node Internet protocol (IP) address (i.e., part of the original request) as well as a remote server node Internet protocol (IP) address data structure. In embodiments, the remote server node Internet protocol (IP) address data structure comprises a plurality of remote server Internet protocol (IP) address port pairs. In embodiments, a remote server Internet protocol (IP) address port pair comprises a real Internet protocol (IP) address and an associated communication port for communicating with the responder remote server node (Remote Server Node 2) using the real Internet protocol (IP) address. It will be appreciated that a response from any of the discovery nodes is optional. It will also be appreciated that the discovery nodes can respond asynchronously.

In embodiments, process 500 continues with Remote Server Node 1 determining 505 a remote server Internet protocol (IP) address port pair to use for communicating with the responder remote server node (Remote Server Node 2). In embodiments, the remote server node Internet protocol (IP) address port pair is selected from the plurality of remote server node Internet protocol (IP) address port pairs based upon a programmatically determined location associated with the remote server node Internet protocol (IP) address port pair.

In embodiments, process 500 continues with Remote Server Node 1 transmitting 506 to the responder remote server node (Remote Server Node 2), using the selected remote server node Internet protocol (IP) address port pair, a handshake stage one message. In embodiments, the handshake stage one message comprises a first digital certificate, a first ephemeral key pair (e1) and a first static key pair (s1). In embodiments, the first static key pair (s1) is extracted from the first digital certificate. In embodiments, the first digital certificate contains verified initiator remote server node identity credentials. In embodiments, the responder remote server node (Remote Server Node 2) validates 506A the first digital certificate before responding to Remote Server Node 1. In embodiments, the responder remote server node (Remote Server Node 2) merges the first static key pair (s1) with the first digital certificate prior to validating the first digital certificate.

In embodiments, process 500 continues with Remote Server Node 1 receiving 507 from the responder remote server node (Remote Server Node 2) a handshake stage two message. In embodiments, the handshake stage two message comprises a second digital certificate. In embodiments, the second digital certificate comprises verified responder remote server node (Remote Server Node 2) identity credentials. In embodiments, the handshake stage two message further comprises a second ephemeral key pair (e2), a second static key pair (s2), a first Diffie-Hellman key (e1e2) determined by performing a first Diffie-Hellman operation on the first ephemeral key pair (e1) and the second ephemeral key pair (e2), a second Diffie-Hellman key (s1e2) determined by performing a second Diffie-Hellman operation on the first static key pair (s1) and the second ephemeral key pair (e2), and a third Diffie-Hellman key (e1s2) determined by performing a third Diffie-Hellman operation on the first ephemeral key pair (e1) and the second static key pair (s2). In embodiments, the second static key pair (s2) is extracted from the second digital certificate.

In embodiments, process 500 continues with Remote Server Node 1 validating 508, by merging the second digital certificate and the second static key pair (s2) and verifying a signature of it, the responder remote server node identity credentials. Remote Server Node 1 then performs a fourth Diffie-Hellman operation using the key pairs provided in the handshake stage two message in order to generate a shared secret key and verifies the responder remote server node identity credentials. Remote Server Node 1 encrypts the group-based communication data packet using the shared secret key. Remote Server Node 1 establishes a secure communication tunnel for communication with the responder remote server node (Remote Server Node 2).

In embodiments, process 500 continues with Remote Server Node 1 transmitting 509, to the responder remote server node (Remote Server Node 2), using the secure communication tunnel, the encrypted group-based communication data packet.

In embodiments, Remote Server Node 1 communicates any subsequently received group-based communication data packets intended for the responder remote server node (Remote Server Node 2) over the secure communication tunnel after having encrypted the packets using the shared secret key.

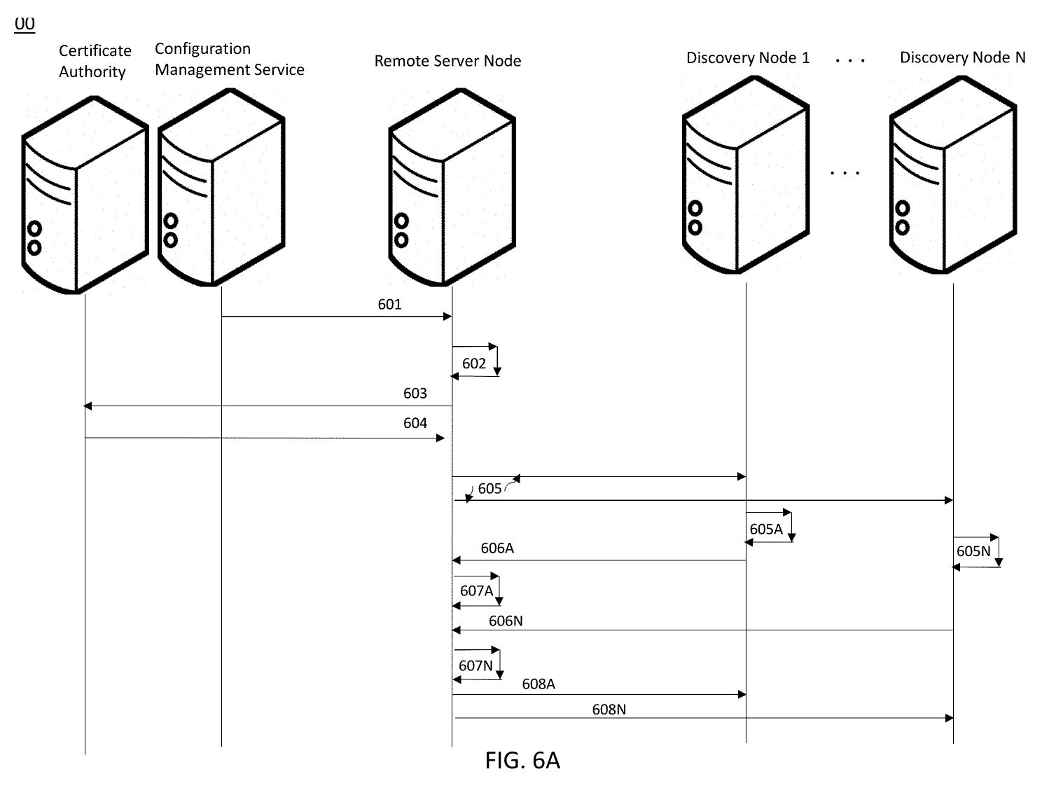

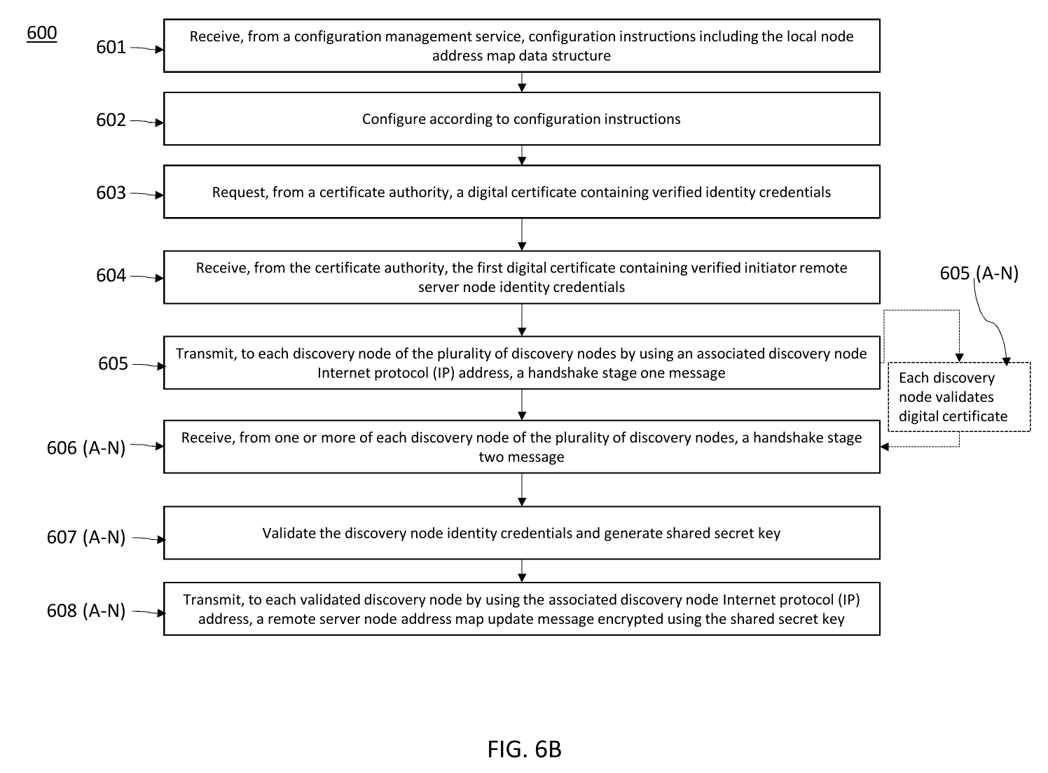

FIGS. 6A and 6B illustrate an exemplary process for configuring a remote server node and establishing secure communication tunnels with discovery nodes, for use with embodiments of the present disclosure. In embodiments, a Remote Server Node establishes secure discovery node communication tunnels with discovery nodes (Discovery Node 1, . . . Discovery Node N).

In embodiments, process 600 begins with Remote Server Node receiving 601, from a configuration management service, configuration instructions including a local node address map data structure. In embodiments, the local node address map data structure contains a plurality of discovery node Internet protocol (IP) addresses. In embodiments, each discovery node Internet protocol (IP) address is associated with a unique discovery node of a plurality of discovery nodes.

In embodiments, process 600 continues with Remote Server Node configuring 602 according to the configuration instructions and storing the local node address map locally.

In embodiments, process 600 continues with Remote Server Node requesting 603, from a certificate authority, a digital certificate containing verified initiator remote server node identity credentials for the Remote Server Node. In embodiments, the verified initiator remote server node identity credentials are verified by the certificate authority.

In embodiments, process 600 continues with Remote Server Node receiving 604, from the certificate authority, the digital certificate containing verified initiator remote server node identity credentials for the Remote Server Node.

In embodiments, process 600 continues with the Remote Server Node simultaneously transmitting 605, to each discovery node of a plurality of discovery nodes (Discovery Node 1, . . . Discovery Node N) by using a discovery node Internet protocol (IP) address associated with each discovery node, a handshake stage one message. In embodiments, the handshake stage one message comprises the digital certificate, an ephemeral key pair (e1), and a static key pair (s1). In embodiments, the static key pair (s1) is extracted from the digital certificate. In embodiments, each discovery node validates (605A-N) the digital certificate. In embodiments, validating a digital certificate involves a request to and a response from the certificate authority.

In embodiments, process 600 continues with Remote Server Node receiving 606A-N, from one or more of the discovery nodes (Discovery Node 1, . . . Discovery Node N), a handshake stage two message. In embodiments, each handshake stage two message comprises a digital certificate containing discovery node identity credentials for each discovery node, a second ephemeral key pair (e2), a second static key pair (s2), a first Diffie-Hellman key (e1e2) determined by performing a first Diffie-Hellman operation on the first ephemeral key pair (e1) and the second ephemeral key pair (e2), a second Diffie-Hellman key (s1e2) determined by performing a second Diffie-Hellman operation on the first static key pair (s1) and the second ephemeral key pair (e2), and a third Diffie-Hellman key (e1s2) determined by performing a Diffie-Hellman operation on the first ephemeral key pair (e1) and the second ephemeral key pair (s2). In embodiments, the second static key pair (s2) is extracted from the digital certificate containing discovery node identity credentials.

In embodiments, process 600 continues with Remote Server Node validating 607A-N, by decrypting each handshake stage two message, the discovery node identity credentials.

In embodiments, process 600 continues with Remote Server Node transmitting 608A-N to each verified discovery node by using the associated discovery node Internet protocol (IP) address, a remote server node address map update message. In embodiments, the remote server node address map update message comprises a secure communication system assigned Internet protocol (IP) address and a remote server node Internet protocol (IP) address data structure. In embodiments, the remote server node Internet protocol (IP) address data structure comprises a plurality of remote server node Internet protocol (IP) address port pairs. In embodiments, each remote server Internet protocol (IP) address port pairs comprises a real Internet protocol (IP) address and an associated communication port.

In embodiments, Remote Server Node periodically transmits remote server node address map update messages to a discovery node.

In embodiments, Remote Server Node simultaneously establishes a plurality of secure discovery node communication tunnels, each discovery node communication tunnel established with each discovery node of a plurality of discovery nodes having discovery node Internet protocol (IP) addresses in the local node address map data structure. In such embodiments, Remote Server Node periodically transmits to each discovery node of the plurality of discovery nodes, using the secure discovery node communication tunnels, remote server node address map update messages.

In embodiments, Remote Server Node stores, in local memory, any received digital certificates.

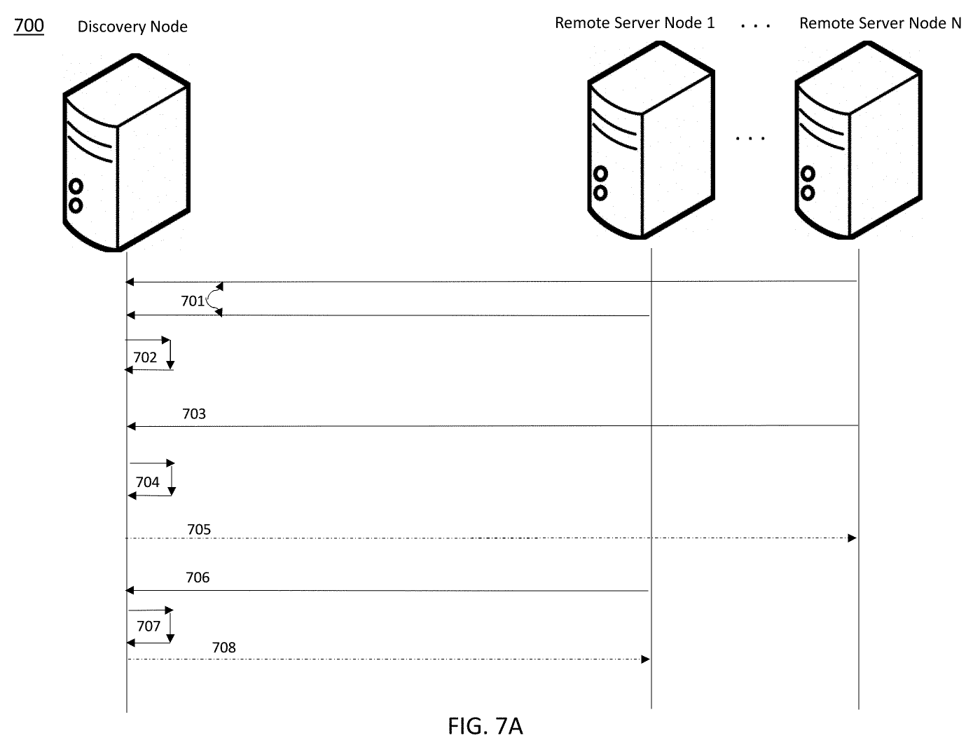

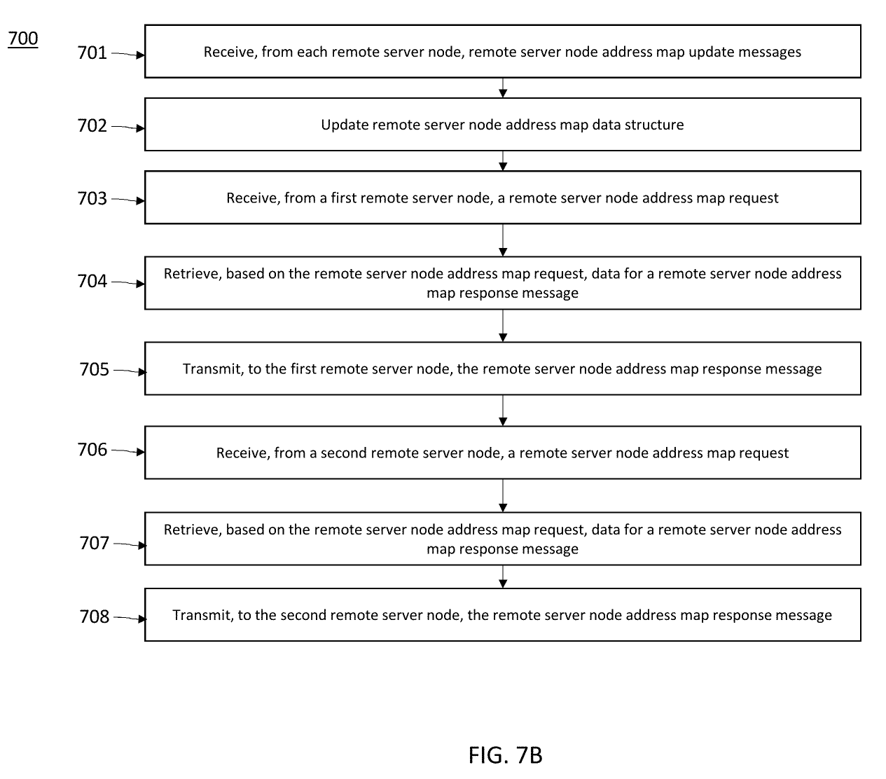

FIGS. 7A and 7B illustrate an exemplary process for communicating with a discovery node, according to embodiments of the present disclosure. In embodiments, a process 700 for communicating with a discovery node includes a Discovery Node receiving 701, from each remote server node (Remote Server Node 1, . . . Remote Server Node N), remote server node address map update messages.

In embodiments, process 700 continues with Discovery Node updating 702 its local remote server node address map data structure based upon any received remote server node address map update messages.

In embodiments, process 700 continues with Discovery Node receiving 703, from a first remote server node (Remote Server Node 1), a remote server node address map request. Discovery Node retrieves 704, based on the remote server node address map request, data for preparing a remote server node address map response message. Discovery Node then transmits 705, to the requesting remote server node (i.e., first remote server node, Remote Server Node 1), the remote server node address map response message. It will be appreciated that response 705 is optional.

In embodiments, process 700 continues with Discovery Node receiving 706, from a second remote server node (Remote Server Node 2), a remote server node address map request. Discovery Node retrieves 707, based on the remote server node address map request, data for preparing a remote server node address map response message. Discovery Node then transmits 708, to the requesting remote server node (i.e., second remote server node, Remote Server Node 2), the remote server node address map response message. It will be appreciated that response 708 is optional.

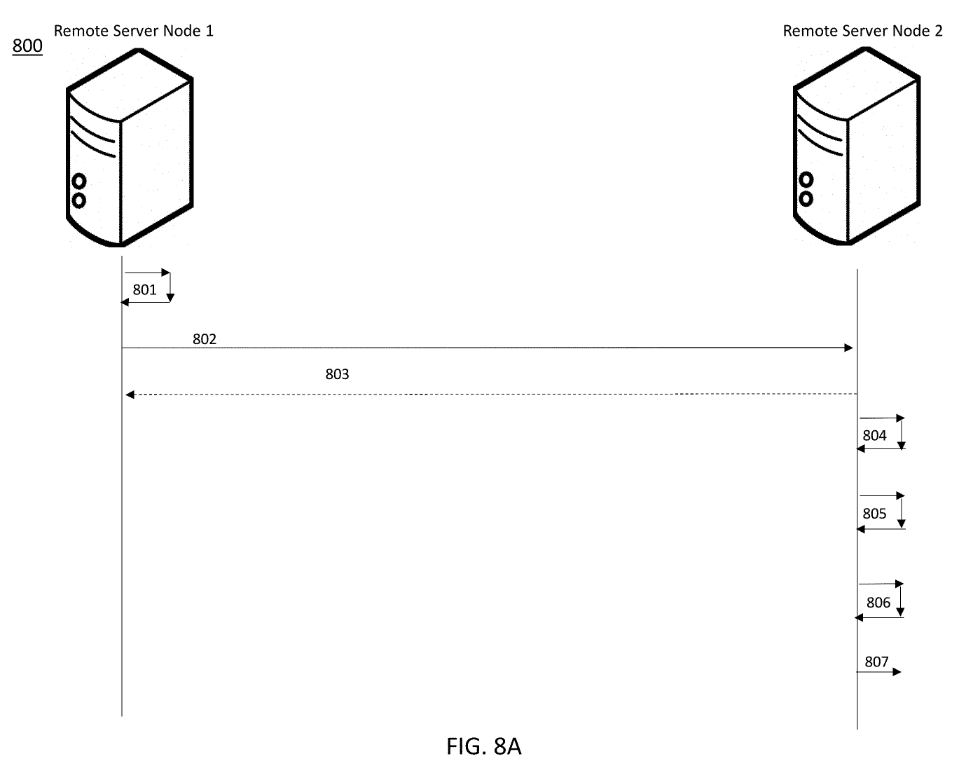

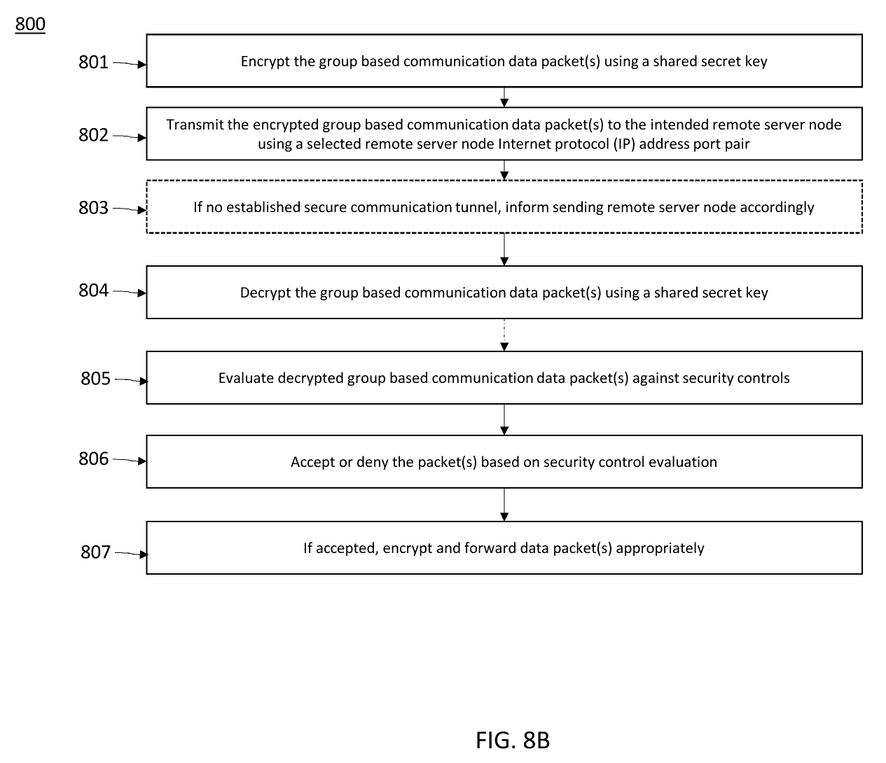

FIGS. 8A and 8B illustrate an exemplary process for secure communication of encrypted group-based communication data between remote server nodes, according to embodiments of the present disclosure. In embodiments, process 800 begins with a Remote Server Node 1 encrypting 801 group-based communication data packet(s) intended for Remote Server Node 2 using a shared secret key that has been established with Remote Server Node 2 according to the processes described herein.

In embodiments, process 800 continues with Remote Server Node 1 transmitting 802 the encrypted group-based communication data packet(s) to Remote Server Node 2 using a selected remote server node Internet protocol (IP) address port pair selected according to the processes described herein.

In embodiments, Remote Server Node 2 may optionally, if Remote Server Node 2 does not have an established secure communication tunnel with Remote Server Node 1, inform 803 Remote Server Node 1 that there has not been a successful handshake between the two.

In embodiments, process 800 continues with Remote Server Node 2 decrypting 804 the encrypted group-based communication packet(s) using the shared secret key.

In embodiments, Remote Server Node 2 evaluates 805 the decrypted group-based communication data packet(s) against security controls. In embodiments, the set of security controls comprises at least one protocol rule, at least one port rule, and one or more of an Internet protocol (IP) address rule, a name rule, and a group(s) rule.

The Remote Server Node 2 may accept or deny 806 the packet(s) based upon the security control evaluation. If the packet(s) are accepted, Remote Server Node 2 encrypts and forwards 807 the packet(s) appropriately.

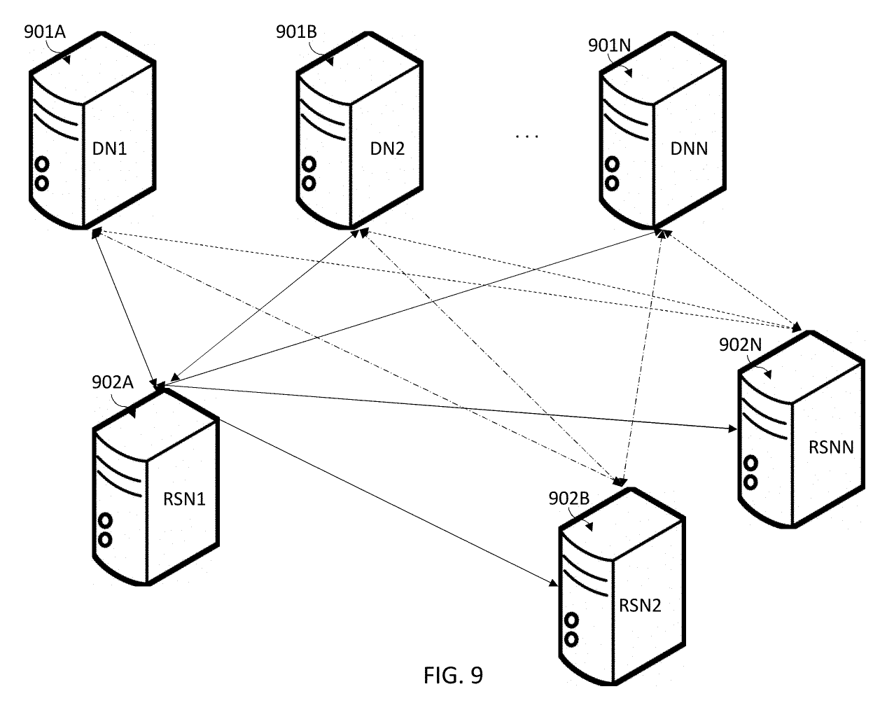

FIG. 9 illustrates an exemplary secure remote server communication system according to embodiments of the present disclosure. In embodiments, a secure remote server communication system comprises a plurality of discovery nodes (DN1-DNN) 901A-901N, a plurality of remote server nodes (RSN1-RSNN) 902A-902N, and a plurality of configuration management service nodes (not shown). It will be appreciated that every remote server node is in communication via a secure discovery node communication tunnel with every discovery node of the system. It will also be appreciated that each remote server node may be in communication with any number of (i.e., one, two, all, etc.) the other remote server nodes of the system via a secure remote server node communication tunnel.

### Additional Implementation Details

Although example processing systems have been described in FIGS. 2A and 2B, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

### CONCLUSION

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation.

1. An apparatus for secure direct remote server communication of encrypted group-based communication data, the apparatus comprising at least one processor and at least one memory storing instructions that, when executed by the at least one processor, cause the apparatus to:
receive, from a remote server node, a first group-based communication data packet intended for a responder remote server node, the responder remote server node associated with a responder remote server node Internet protocol (IP) address;
upon determining that the responder remote server node Internet protocol (IP) address is not stored in a local node address map data structure, simultaneously transmit a remote server node address map requests to one or more discovery nodes of a plurality of discovery nodes having discovery node Internet protocol (IP) addresses stored in the local node address map data structure, the remote server node address map requests comprising the responder remote server Internet protocol (IP) address;
receive, from one or more discovery nodes, remote server node address map response messages, the remote server node address map response messages comprising the responder remote server Internet protocol (IP) address and a remote server node Internet protocol (IP) address data structure comprising a plurality of remote server node Internet protocol (IP) address port pairs, each remote server Internet protocol (IP) address port pair comprising a real Internet protocol (IP) address and an associated communication port for communicating with the responder remote server node;
transmit, to the responder remote server node using a remote server node Internet protocol (IP) address port pair, a first handshake stage one message, wherein the first handshake stage one message comprises a first digital certificate and a first ephemeral key pair (e1) and a first static key pair (s1), and wherein the first static key pair (s1) is extracted from the first digital certificate, the first digital certificate containing verified initiator remote server node identity credentials;
receive, from the responder remote server node, a first handshake stage two message, wherein the first handshake stage two message comprises a second digital certificate containing verified responder remote server node identity credentials for the responder remote server node, a second ephemeral key pair (e2), a second static key pair (s2), a first Diffie-Hellman key (e1e2) determined by performing a first Diffie-Hellman operation on the first ephemeral key pair (e1) and the second ephemeral key pair (e2), a second Diffie-Hellman key (s1e2) determined by performing a second Diffie-Hellman operation on the first static key (s1) and the second ephemeral key pair (e2), and a third Diffie-Hellman key (e1s2) determined by performing a third Diffie-Hellman operation on the first ephemeral key pair (e1) and the second static key pair (s2), wherein the second static key (s2) extracted from the second digital certificate, and wherein the responder remote server node validates the first digital certificate before transmitting the first handshake stage two message;
validate, by merging the second digital certificate with the second static key pair (s2), the responder remote server node identity credentials;
encrypt the first group-based communication data packet using a first shared secret key generated based on the first Diffie-Hellman key (e1e2), the second Diffie-Hellman key (s1e2), and the third Diffie-Hellman key (e1s2);
establish a first secure communication tunnel for communication with the responder remote server node; and
transmit, to the responder remote server node using the first secure communication tunnel, the encrypted first group-based communication data packet.

2. The apparatus of claim 1, wherein the remote server node Internet protocol (IP) address port pair is selected from the plurality of remote server node Internet protocol (IP) address port pairs based upon a programmatically determined location associated with the remote server node Internet protocol (IP) address port pair.

3. The apparatus of claim 1, wherein subsequent received group-based communication data packets intended for the responder remote server node are automatically encrypted using the first shared secret key and transmitted to the responder remote server node using the first secure communication tunnel.

4. The apparatus of claim 1, wherein the at least one memory stores further instructions that, when executed by the at least one processor, cause the apparatus to establish a first secure discovery node communication tunnel with the first discovery node.

5. The apparatus of claim 4, wherein establishing the first secure discovery node communication tunnel with the first discovery node comprises:
receiving, from a configuration management service, the local node address map data structure, the local node address map data structure containing a plurality of discovery node Internet protocol (IP) addresses, each discovery node Internet protocol (IP) address associated with a unique discovery node of a plurality of discovery nodes;
receiving, from the configuration management service, the first digital certificate containing verified initiator remote server node identity credentials, the verified initiator remote server node identity credentials having been verified by the configuration management service;
transmitting, to a first discovery node of the plurality of discovery nodes by using a first discovery node Internet protocol (IP) address associated with the first discovery node, a second handshake stage one message, wherein the second handshake stage one message comprises the first digital certificate, the first ephemeral key pair (e1) and the first static key pair (s1), wherein the first digital certificate contains the first static key pair (s1);
receiving, from the first discovery node of the plurality of discovery nodes, a second handshake stage two message, wherein the second handshake stage two message comprises a third digital certificate containing first discovery node identity credentials for the first discovery node, a third ephemeral key pair (e3), a third static key pair (s3), a fourth Diffie-Hellman key (e1e3) determined by performing a fourth Diffie-Hellman operation on the first ephemeral key pair (e1) and the third ephemeral key pair (e3), a fifth Diffie-Hellman key (s1e3) determined by performing a fifth Diffie-Hellman operation on the first static key pair (s3) and the third ephemeral key pair (e3), wherein the third static key pair (s4) is extracted from the third digital certificate, and wherein the first discovery node validates the third digital certificate before transmitting the second handshake stage two message;
validating, by decrypting the second handshake stage two message, the first discovery node identity credentials; and
transmitting, to the first discovery node by using the first discovery node Internet protocol (IP) address, a first remote server node address map update message, wherein the first remote server node address map update message comprises a first secure communication system assigned Internet protocol (IP) address and a first remote server node Internet protocol (IP) address data structure comprising a plurality of remote server node Internet protocol (IP) address port pairs, each remote server Internet protocol (IP) address port pairs comprising a real Internet protocol (IP) address and an associated communication port.

6. The apparatus of claim 5, wherein the at least one memory stores further instructions that, when executed by the at least one processor, cause the apparatus to:
periodically transmit to the first discovery node, using the first secure discovery node communication tunnel, remote server node address map update messages.

7. The apparatus of claim 6, at least one memory stores further instructions that, when executed by the at least one processor, cause the apparatus to simultaneously establish a plurality of secure discovery node communication tunnels with each discovery node of a plurality of discovery nodes having discovery node Internet protocol (IP) addresses in the local node address map data structure.

8. The apparatus of claim 7, wherein the at least one memory stores further instructions that, when executed by the at least one processor, cause the apparatus to:
periodically transmit to each discovery node of the plurality of discovery nodes, using the plurality of secure discovery node communication tunnels, remote server node address map update messages.

9. The apparatus of claim 1, wherein the at least one memory stores further instructions that, when executed by the at least one processor, cause the apparatus to:
store, in the at least one memory, the second digital certificate.

10. The apparatus of claim 1, wherein the responder remote server node decrypts the encrypted first group-based communication data packet using the first shared secret key.

11. The apparatus of claim 10, wherein the responder remote server node evaluates the decrypted first group-based communication data packet using a set of security controls.

12. The apparatus of claim 11, wherein the set of security controls comprises at least one protocol rule, at least one port rule, and one or more of an Internet protocol (IP) address rule, a name rule, and a group rule.

13. A system for secure direct remote server communication of encrypted group-based communication data, the system comprising at least one server and at least one repository, the at least one server comprising at least one processor and at least one memory storing instructions that, when executed by the at least one processor, cause the system to:
receive, from a remote server node, a first group-based communication data packet intended for a responder remote server node, the responder remote server node associated with a responder remote server node Internet protocol (IP) address;
upon determining that the responder remote server node Internet protocol (IP) address is not stored in a local node address map data structure, simultaneously transmit a remote server node address map requests to one or more discovery nodes of a plurality of discovery nodes having discovery node Internet protocol (IP) addresses stored in the local node address map data structure, the remote server node address map requests comprising the responder remote server Internet protocol (IP) address;
receive, from one or more discovery nodes, remote server node address map response messages, the remote server node address map response messages comprising the responder remote server Internet protocol (IP) address and a remote server node Internet protocol (IP) address data structure comprising a plurality of remote server node Internet protocol (IP) address port pairs, each remote server Internet protocol (IP) address port pair comprising a real Internet protocol (IP) address and an associated communication port for communicating with the responder remote server node;
transmit, to the responder remote server node using a remote server node Internet protocol (IP) address port pair, a first handshake stage one message, wherein the first handshake stage one message comprises a first digital certificate and a first ephemeral key pair (e1) and a first static key pair (s1), and wherein the first static key pair (s1) is extracted from the first digital certificate, the first digital certificate containing verified initiator remote server node identity credentials;
receive, from the responder remote server node, a first handshake stage two message, wherein the first handshake stage two message comprises a second digital certificate containing verified responder remote server node identity credentials for the responder remote server node, a second ephemeral key pair (e2), a second static key pair (s2), a first Diffie-Hellman key (e1e2) determined by performing a first Diffie-Hellman operation on the first ephemeral key pair (e1) and the second ephemeral key pair (e2), a second Diffie-Hellman key (s1e2) determined by performing a second Diffie-Hellman operation on the first static key (s1) and the second ephemeral key pair (e2), and a third Diffie-Hellman key (e1s2) determined by performing a third Diffie-Hellman operation on the first ephemeral key pair (e1) and the second static key pair (s2), wherein the second static key (s2) extracted from the second digital certificate, and wherein the responder remote server node validates the first digital certificate before transmitting the first handshake stage two message;
validate, by merging the second digital certificate with the second static key pair (s2), the responder remote server node identity credentials;
encrypt the first group-based communication data packet using a first shared secret key generated based on the first Diffie-Hellman key (e1e2), the second Diffie-Hellman key (s1e2), and the third Diffie-Hellman key (e1s2);
establish a first secure communication tunnel for communication with the responder remote server node; and
transmit, to the responder remote server node using the first secure communication tunnel, the encrypted first group-based communication data packet.

14. The system of claim 13, wherein the remote server node Internet protocol (IP) address port pair is selected from the plurality of remote server node Internet protocol (IP) address port pairs based upon a programmatically determined location associated with the remote server node Internet protocol (IP) address port pair.

15. The system of claim 13, wherein subsequent received group-based communication data packets intended for the responder remote server node are automatically encrypted using the first shared secret key and transmitted to the responder remote server node using the first secure communication tunnel.

16. The system of claim 13, wherein the at least one memory stores further instructions that, when executed by the at least one processor, cause the system to establish a first secure discovery node communication tunnel with the first discovery node.

17. The system of claim 16, wherein establishing the first secure discovery node communication tunnel with the first discovery node comprises:
receiving, from a configuration management service, the local node address map data structure, the local node address map data structure containing a plurality of discovery node Internet protocol (IP) addresses, each discovery node Internet protocol (IP) address associated with a unique discovery node of a plurality of discovery nodes;
receiving, from the configuration management service, the first digital certificate containing verified initiator remote server node identity credentials, the verified initiator remote server node identity credentials having been verified by the configuration management service;
transmitting, to a first discovery node of the plurality of discovery nodes by using a first discovery node Internet protocol (IP) address associated with the first discovery node, a second handshake stage one message, wherein the second handshake stage one message comprises the first digital certificate, the first ephemeral key pair (e1) and the first static key pair (s1), wherein the first digital certificate contains the first static key pair (s1);
receiving, from the first discovery node of the plurality of discovery nodes, a second handshake stage two message, wherein the second handshake stage two message comprises a third digital certificate containing first discovery node identity credentials for the first discovery node, a third ephemeral key pair (e3), a third static key pair (s3), a fourth Diffie-Hellman key (e1e3) determined by performing a fourth Diffie-Hellman operation on the first ephemeral key pair (e1) and the third ephemeral key pair (e3), a fifth Diffie-Hellman key (s1e3) determined by performing a fifth Diffie-Hellman operation on the first static key pair (s3) and the third ephemeral key pair (e3), wherein the third static key pair (s4) is extracted from the third digital certificate, and wherein the first discovery node validates the third digital certificate before transmitting the second handshake stage two message;
validating, by decrypting the second handshake stage two message, the first discovery node identity credentials; and
transmitting, to the first discovery node by using the first discovery node Internet protocol (IP) address, a first remote server node address map update message, wherein the first remote server node address map update message comprises a first secure communication system assigned Internet protocol (IP) address and a first remote server node Internet protocol (IP) address data structure comprising a plurality of remote server node Internet protocol (IP) address port pairs, each remote server Internet protocol (IP) address port pairs comprising a real Internet protocol (IP) address and an associated communication port.

18. The system of claim 17, wherein the at least one memory stores further instructions that, when executed by the at least one processor, cause the system to:
periodically transmit to the first discovery node, using the first secure discovery node communication tunnel, remote server node address map update messages.

19. The system of claim 18, wherein the at least one memory stores further instructions that, when executed by the at least one processor, cause the system to simultaneously establish a plurality of secure discovery node communication tunnels with each discovery node of a plurality of discovery nodes having discovery node Internet protocol (IP) addresses in the local node address map data structure.

20. The system of claim 19, wherein the at least one memory stores further instructions that, when executed by the at least one processor, cause the system to:
periodically transmit to each discovery node of the plurality of discovery nodes, using the plurality of secure discovery node communication tunnels, remote server node address map update messages.

21. The system of claim 13, wherein the at least one memory stores further instructions that, when executed by the at least one processor, cause the system to:
store, in the at least one memory, the second digital certificate.

22. The system of claim 13, wherein the responder remote server node decrypts the encrypted first group-based communication data packet using the first shared secret key.

23. The system of claim 22, wherein the responder remote server node evaluates the decrypted first group-based communication data packet using a set of security controls.

24. The system of claim 23, wherein the set of security controls comprises at least one protocol rule, at least one port rule, and one or more of an Internet protocol (IP) address rule, a name rule, and a group rule.

25-36. (canceled)
